(19) United States
(12) Patent Application Publication
(10) Pub. No.: US 2015/0121284 A1
(43) Pub. Date: Apr. 30, 2015

(54) METHOD FOR INFORMATION PROCESSING AND ELECTRONIC APPARATUS THEREOF

(71) Applicant: Lenovo (Beijing) Co., Ltd., Beijing (CN)

(72) Inventors: Jing WANG, Beijing (CN); Chao WANG, Beijing (CN)

(73) Assignee: Lenovo (Beijing) Co., Ltd., Beijing (CN)

(21) Appl. No.: 14/230,660

(22) Filed: Mar. 31, 2014

(30) Foreign Application Priority Data
Oct. 28, 2013 (CN) 201310516844.7
Oct. 28, 2013 (CN) 201310517973.8
Oct. 28, 2013 (CN) 201310518050.4

(51) Int. Cl. G06F 3/0481; G06F 3/0488; G06F 3/041; G06F 3/0484

(52) U.S. Cl. CPC G06F 3/0481; G06F 3/04845; G06F 3/04886; G06F 3/0416
USPC 715/773

(57) ABSTRACT

A method for information processing and an electronic apparatus thereof are provided in the embodiment of the disclosure. The electronic apparatus includes a touch display unit, and a first non-full-screen window is displayed on the touch display unit. The first non-full-screen window includes a first display area and a second function area, the second function area includes at least one virtual function key, and the first non-full-screen window is smaller than the display area of the touch display unit. Parsing the first operation for a virtual function key in the second function area to obtain a first parsing result; determining a first transformation parameter in accordance with the first parsing result; and transforming the first non-full-screen window by using the first transformation parameter to determine a second non-full-screen window for replacing the first non-full-screen window such that the application is displayed within the second non-full-screen window.

The present application claims the priority to Chinese Patent Application No. 201310517973.8, entitled as “METHOD FOR INFORMATION PROCESSING AND ELECTRONIC APPARATUS THEREOF”, filed on Oct. 28, 2013 with State Intellectual Property Office of People's Republic of China, which is incorporated herein by reference in its entirety.

The present application claims the priority to Chinese Patent Application No. 201310516844.7, entitled as “METHOD FOR INFORMATION PROCESSING AND ELECTRONIC APPARATUS THEREOF”, filed on Oct. 28, 2013 with State Intellectual Property Office of People's Republic of China, which is incorporated herein by reference in its entirety.

The present application claims the priority to Chinese Patent Application No. 201310518050.4, entitled as “METHOD FOR INFORMATION PROCESSING AND ELECTRONIC APPARATUS THEREOF”, filed on Oct. 28, 2013 with State Intellectual Property Office of People's Republic of China, which is incorporated herein by reference in its entirety.

### FIELD

The present disclosure relates to the information processing technology, and in particular, to a method for information processing and an electronic apparatus thereof.

### BACKGROUND

Screens of the early electronic apparatus are with a smaller size and a lower resolution, and are operated by a corresponding operating system such as Android to display an application in a full-screen window. Consider the following scenarios.

In the case where the screen size of the electronic apparatus increases, if a non-full-screen window display is provided for the application, i.e., all applications in the electronic apparatus are allowed to be displayed simultaneously on the display unit of the electronic apparatus in non-full-screen windows, no effective solution in related art to the problem of how to perform management operations such as moving, closing, and scaling on an open non-full-screen window quickly and conveniently to save operating time and improve user experience

### SUMMARY

In view of this, the embodiments of the disclosure provide a method for information processing and an electronic apparatus thereof so as to perform management operations such as moving, closing and scaling on an open non-full-screen window quickly and conveniently, thus saving operating time and improving user experience.

To achieve the above object, the technical solutions of the embodiments of the disclosure are implemented as follows.

A method for information processing applied to an electronic apparatus with a touch display unit, wherein M application identifiers one-to-one corresponding to M applications and a first non-full-screen window including a first display area and a second function area are displayed on the touch display unit, M being a positive integer; the first display area is used for displaying a first application, and the second function area includes at least one virtual function key, the first non-full-screen window is smaller than the display area of the touch display unit, and the method includes:

acquiring a first operation to the virtual function key in the second function area;

parsing the first operation to obtain a first parsing result, wherein the first parsing result indicates information for adjusting the first non-full-screen window;

determining a first transformation parameter in accordance with the first parsing result; and

transforming the first non-full-screen window by using the first transformation parameter to determine a second non-full-screen window for replacing the first non-full-screen window to make the first application displayed within the second non-full-screen window;

wherein the first non-full-screen window is different from the second non-full-screen window and the first transformation parameter at least includes a parameter value, a matrix, a parameter group or a parameter set.

The second function area includes a first virtual function key indicative of moving the first non-full-screen window and/or a second virtual function key indicative of scaling the first non-full-screen window.

Determining a first transformation parameter in accordance with the first parsing result includes:

determining the first transformation parameter in accordance with a distance and a direction for moving the first non-full-screen window indicated by the first parsing result and/or an amplitude and a direction for scaling the first non-full-screen window indicated by the first parsing result in the case where an operation object of the first operation is the first virtual function key; and

transforming the first non-full-screen window by using the first transformation parameter to determine a second non-full-screen window.

The second function area further includes a third virtual function key indicative of closing the first non-full-screen window; and the method further includes:

acquiring the first operation for the third virtual function key in the second function area; and

closing the first non-full-screen window displayed on the touch display unit in response to the first operation for the third virtual function key.

The second function area further includes a fourth virtual function key indicative of full-screen displaying the first non-full-screen window; and the method further includes:

acquiring the first operation for the fourth virtual function key in the second function area; and

full-screen displaying the first non-full-screen window in response to the first operation for the fourth virtual function key.

Transforming the first non-full-screen window by using the first transformation parameter to determine a second non-full-screen window includes:

reading graphic buffer data of the first application;

converting the read graphic buffer data into graphic buffer data corresponding to the second non-full-screen window by using the first transformation parameter, and combining the graphic buffer data for the second non-full-screen window into frame buffer data corresponding to the touch display unit; and

displaying the second non-full-screen window of the first application on the touch display unit by using the frame buffer data.

Determining a first transformation parameter in accordance with the first parsing result includes:

displaying a third window for replacing the first non-full-screen window on the touch display unit to make the first application displayed in the third window in response to the first operation in the case where the first parsing result meets a first condition; the third window being different from the first non-full-screen window;

determining the first transformation parameter in response to the first operation in the case where the first parsing result meets a second condition.

The first parsing result includes a duration parameter of a first touch event corresponding to the virtual function key which is triggered by the first operation; and

displaying the third window for replacing the first non-full-screen window on the touch display unit to make the first application displayed in the third window in response to the first operation in the case where the first parsing result meets the first condition includes:

displaying the third window for replacing the first non-full-screen window on the touch display unit to make the first application displayed in the third window in the case where the duration parameter of the touch event received by the virtual function key is smaller than a preset threshold; the third window corresponding to the display area of the touch display unit.

The first parsing result further includes a displacement parameter of the first touch event; and

determining the first transformation parameter in response to the first operation in the case where the first parsing result meets the second condition includes:

determining the first transformation parameter according to the displacement parameter of the first touch event in the case where the duration parameter of the first touch event is equal to or greater than a preset threshold; and

transforming the first non-full-screen window into a second non-full-screen window with a first display area and a second function area by using the determined first transformation parameter to make the first application displayed in the first display area of the second non-full-screen window; the second non-full-screen window being bigger or smaller than the first non-full-screen window and being different from the third window.

The first parsing result further includes a touch-point parameter of the first touch event; and

the method further includes, before determining the first transformation parameter in response to the first operation,

judging whether the number of touch points sensed by the virtual function key, which is indicated by the touch-point parameter, meets a third condition; performing the step of determining the first transformation parameter in response to the first operation in the case where the number of the touch points meets the third condition; and determining the first transformation parameter according to the displacement parameter of the first touch event in the case where the number of the touch points does not meet the third condition; and

transforming the third window into a fourth non-full-screen window with a first display area and a second function area by using the determined first transformation parameter to make the first application displayed in the first display area of the fourth non-full-screen window; the position of the fourth window being different from the position of the third window.

Before acquiring the first operation for the virtual function key in the second function area, full-screen display windows corresponding to multiple applications being transformed by the electronic apparatus by using a second transformation parameter, to obtain non-full-screen windows of the applications, wherein in the case where N non-full-screen windows is operated, the method of determining the first non-full-screen window from the N non-full-screen windows includes:

determining the first non-full-screen window in a first state among N non-full-screen windows that are opened currently;

setting the first non-full-screen window to a first display state;

acquiring first display information corresponding to the first non-full-screen window;

determining display information of the second function area according to the first display information; and

generating the first non-full-screen window by using the first display information and the display information of the second function area.

The first non-full-screen window in the first state is the non-full-screen window, in which an interaction event takes place for the last time, among the N non-full-screen windows in which applications are operated in the non-full-screen mode.

Generating the first non-full-screen window by using the first display information and the display information of the second function area includes:

generating frame buffer data according to the first display information in the first non-full-screen window and the display information of the second function area; and

displaying the frame buffer data in the display area of the touch display unit.

Before the generating frame buffer data of the display module according to the first display information in the first non-full-screen window and the display information of the second function area,

adding a display parameter of the second function area into the display information in the second function area.

Determining display information of the second function area according to the first display information includes:

extracting a display position of the first display area of the first non-full-screen window from the first display information;

determining a display coordinate of the second function area according to the display position of the first display area, and determining graphic buffer data of the second function area; and

combining the display coordinate of the second function area and the graphic buffer data into the display information of the second function area.

An electronic apparatus with a touch display unit, wherein M application identifiers one-to-one corresponding to M applications and a first non-full-screen window including a first display area and a second function area are displayed on the touch display unit, M being a positive integer; the first display area is used for displaying a first application, and the second function area includes at least one virtual function key, the first non-full-screen window being smaller than the display area of the touch display unit, and the electronic apparatus further includes:

an acquiring unit, configured to acquire a first operation to the virtual function key in the second function area;

a parsing unit, configured to parse the first operation to obtain a first parsing result, wherein the first parsing result indicates information for adjusting the first non-full-screen window;

a first determining unit, configured to determine a first transformation parameter in accordance with the first parsing result, wherein the first transformation parameter at least includes a parameter value, a matrix, a parameter group or a parameter set; and

a second determining unit, configured to transform the first non-full-screen window by using the first transformation parameter to determine a second non-full-screen window for replacing the first non-full-screen window to make the first application displayed within the second non-full-screen window.

The touch display unit is further configured to display, on the second function area, a first virtual function key indicative of moving the first non-full-screen window and/or a second virtual function key indicative of scaling the first non-full-screen window.

The first determining unit is further configured to determine the first transformation parameter in accordance with the distance and direction for moving the first non-full-screen window indicated by the first parsing result and/or an amplitude and a direction for scaling the first non-full-screen window indicated by the first parsing result in the case where an operation object of the first operation is the first virtual function key.

The touch display unit is further configured to display, on the second function area, a third virtual function key indicative of closing the first non-full-screen window;

the acquiring unit is further configured to acquire the first operation for the third virtual function key in the second function area; and

the touch display unit is further configured to close the first non-full-screen window displayed on the touch display unit in response to the first operation for the third virtual function key.

The touch display unit is further configured to display, on the second function area, a fourth virtual function key indicative of full-screen displaying the first non-full-screen window;

the acquiring unit is further configured to acquire the first operation for the fourth virtual function key in the second function area; and

the touch display unit is further configured to full-screen display the first non-full-screen window in response to the first operation for the fourth virtual function key.

The first determining unit is further configured to:

read graphic buffer data of the first application;

convert the read graphic buffer data into graphic buffer data corresponding to the second non-full-screen window by using the first transformation parameter, and combine the graphic buffer data for the second non-full-screen window into frame buffer data corresponding to the touch display unit; and

display the second non-full-screen window of the first application on the touch display unit by using the frame buffer data, the second non-full-screen window being used for replacing the first non-full-screen window to make the first application displayed within the corresponding second non-full-screen window.

The parsing unit is further configured to determining whether the first parsing result meets a first condition or meets a second condition;

the electronic apparatus further includes a second processing unit, configured to display a third window for replacing the first non-full-screen window on the touch display unit to display the first application in the third window in response to the first operation in the case where the first parsing result meets the first condition; the third window being different from the first non-full-screen window; and

the second determining unit, further configured to, in the case where the first parsing result meets the second condition, acquire a first transformation parameter, and transform the first non-full-screen window into a second non-full-screen window by using the first transformation parameter to display the first application in the second non-full-screen window in response to the first operation; the second non-full-screen window being different from either of the first non-full-screen window or the third window.

The first parsing result includes a duration parameter of a first touch event corresponding to the virtual function key which is triggered by the first operation; and

the second processing unit is further configured to, in the case where the duration parameter of the touch event received by the virtual function key is shorter than a preset threshold, display the third window for replacing the first non-full-screen window on the touch display unit to display the first application in the third window; the third window corresponding to the display area of the touch display unit.

The first parsing result further includes a displacement parameter of the first touch event; and

the second determining unit is configured to, in the case where the duration parameter of the first touch event is equal to or longer than the preset threshold, determine the first transformation parameter according to the displacement parameter of the first touch event; and transform the first non-full-screen window into a second non-full-screen window with a first display area and a corresponding second function area by using the determined first transformation parameter, to display the first application in the first display area of the second non-full-screen window; the second non-full-screen window being bigger or smaller than the first non-full-screen window and being different from the third window.

The first parsing result further includes a touch-point parameter of the first touch event; and

the electronic apparatus further includes: a judging unit and a fourth processing unit;

wherein the judging unit is configured to judge whether the number of touch points sensed by the virtual function key, which is indicated by the touch-point parameter, meets a third condition; trigger the second determining unit in the case where the number of the touch points meets the third condition; and trigger the fourth processing unit in the case where the number of the touch points does not meet the third condition; and

the fourth processing unit is configured to determine a corresponding first transformation parameter according to the displacement parameter of the first touch event; and transform the third window into a fourth window with a corresponding first display area and a corresponding second function area by using the determined first transformation parameter, to display the first application in the first display area of the fourth window; the position of the fourth window being different from the position of the third window.

The electronic apparatus further includes a processing unit;

the touch display unit is further configured to transform a full-screen display window corresponding to the application by using a second transformation parameter; and select a first non-full-screen window in a first state from non-full-screen windows that are opened currently in the touch display unit in the case where N windows in which the application is run in a non-full-screen mode are opened, where N is an integer greater than or equal to 1, and the non-full-screen window in the non-full-screen mode is opened; and

the processing unit is configured to run a plurality applications; display, in a display area of the touch display unit, the first non-full-screen window in the first state determined among the non-full-screen windows that are opened currently; set the first non-full-screen window to a first display state; acquire first display information corresponding to the first non-full-screen window; determine display information of a second function area according to the first display information; and generate the first non-full-screen window by using the first display information and the display information of the second function area, and display the first non-full-screen window in the display area of the touch display unit.

The processing unit is further configured to switch the non-full-screen window in a second state into a second display state different from the first display state.

The processing unit is further configured to set, as the first non-full-screen window in the first state, the non-full-screen window, in which an interaction event takes place for the last time, among the N windows in which the application is run in the non-full-screen mode.

In an embodiment of the disclosure, the first non-full-screen window is transformed by using the first transformation parameter, and it is achieved that the application is displayed in the non-full-screen window; and the management operations for the second function area are received via the virtual function key, and the management operations such as moving, closing and scaling are performed on the second function area quickly and operating time is saved conveniently and user's experience is improved.

According to an embodiment of the disclosure, in the case where the first application is displayed in the first non-full-screen window, the first operation of an electronic apparatus user may be received via the virtual function key, and a respective transforming operation may be performed on the first non-full-screen window in response to the first operation in the case where the first parsing result corresponding to the first operation meets the first condition or the second condition. The transforming operation may include operations such as full-screen displaying, scaling and moving. Therefore, different transforming operations may be performed by the electronic apparatus user through only the virtual function key, the operating time is significantly saved and the user's experience is improved.

With the method for information processing for information processing and an electronic apparatus thereof provided in the disclosure, a first non-full-screen window in a first state is determined among non-full-screen windows that are opened currently; the first non-full-screen window is set to a first display state; first display information corresponding to the first non-full-screen window is obtained; display information of a second function area is determined according to the first display information; and the first non-full-screen window is generated by using the first display information and the display information of the second function area. In this way, the second function area is displayed only in the non-full-screen window in the first state, the amount of second function areas displayed on the electronic apparatus is reduced, the mis-operations of the user are decreased, thus the use experience of the user is improved and the ease of use of a system with a plurality of non-full-screen windows is ensured.

### BRIEF DESCRIPTION OF THE DRAWINGS

FIG. 1a is a schematic flow chart of a method for according to an embodiment of the disclosure;

FIG. 1b is a schematic diagram of the case of a second non-full-screen window of an application 1 having an overlapping region with a second non-full-screen window of an application 2 according to an embodiment of the disclosure;

FIG. 2a is a schematic flow chart of a method for information processing according to an embodiment of the disclosure;

FIG. 2b is a schematic diagram of a first display area and a second function area of a first non-full-screen window according to an embodiment of the disclosure;

FIG. 3a is a schematic flow chart of a method for information processing according to an embodiment of the disclosure;

FIG. 3b is a schematic diagram of a first display area and a second function area of a first non-full-screen window according to an embodiment of the disclosure;

FIG. 4a is a schematic flow chart of a method for information processing according to an embodiment of the disclosure;

FIG. 4b is a schematic diagram of a first display area and a second function area of a first non-full-screen window according to an embodiment of the disclosure;

FIG. 5a is a schematic flow chart of a method for information processing according to an embodiment of the disclosure;

FIG. 5b is a schematic diagram of a first display area and a second function area of a first non-full-screen window according to an embodiment of the disclosure;

FIG. 6 is a schematic structural diagram of an electronic apparatus according to an embodiment of the disclosure;

FIG. 7 is a schematic structural diagram of an electronic apparatus according to an embodiment of the disclosure;

FIG. 8 is a schematic structural diagram of an electronic apparatus according to an embodiment of the disclosure;

FIG. 9a is a schematic diagram for a first non-full-screen window of a touch display unit of an electronic apparatus according to an embodiment of the disclosure;

FIG. 9b is a flowchart for an method for information processing according to an embodiment of the disclosure;

FIG. 10a is a flowchart for displaying a first application in a second non-full-screen window according to an embodiment of the disclosure;

FIG. 10b is a schematic diagram for the case of a second non-full-screen window 1 having a overlapping area with a second non-full-screen window 2 according to an embodiment of the disclosure;

FIG. 11a is a schematic diagram for the first non-full-screen window of the touch display unit of the electronic apparatus according to an embodiment of the disclosure;

FIG. 11b is a flowchart for the method for information processing according to an embodiment of the disclosure;

FIG. 12a is a schematic diagram for the first non-full-screen window of the touch display unit of the electronic apparatus according to an embodiment of the disclosure;

FIG. 12b is a flowchart for the method for information processing according to an embodiment of the disclosure;

FIG. 13 is a schematic flow chart of a method for information processing according to an embodiment of the disclosure;

FIG. 14 is a schematic diagram of display effect according to an embodiment of the disclosure;

FIG. 15 is a schematic diagram of display effect according to an embodiment of the disclosure;

FIG. 16 is a schematic diagram of display effect according to an embodiment of the disclosure; and

FIG. 17 is a schematic structural diagram of an electronic apparatus according to an embodiment of the disclosure.

### DETAILED DESCRIPTION OF THE EMBODIMENTS

The disclosure will be described in further detail below in conjunction with accompanying drawings and specific embodiments.

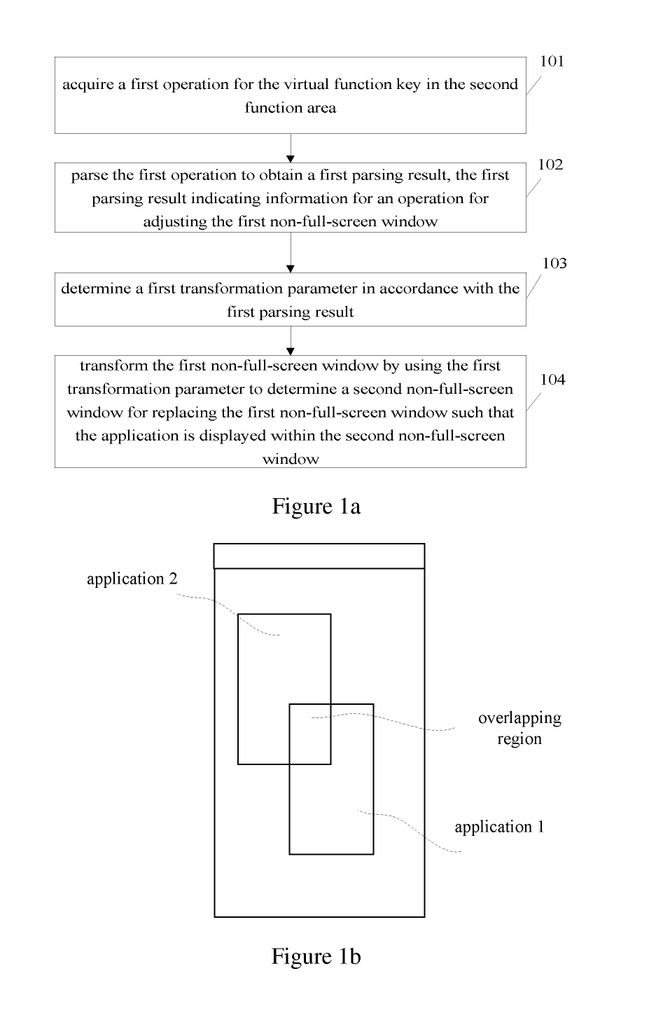

In an embodiment of the disclosure, it is provided a method for information processing. The method for information processing is applied to an electronic apparatus with a touch display unit, wherein M application identifiers one-to-one corresponding to M applications and a first non-full-screen window including a first display area and a second function area are displayed on the touch display unit, M being a positive integer; the first display area is used for displaying a first application, and the second function area includes at least one virtual function key, the first non-full-screen window is smaller than the display area of the touch display unit. FIG. 1a is a schematic flow chart of a method for information processing according to an embodiment of the disclosure, and as shown in FIG. 1a, the method includes steps 101 to 104.

Step 101: acquiring a first operation for the virtual function key in the second function area.

For example, the second function area includes virtual function keys corresponding to operations such as moving, scaling, and closing.

Since the first non-full-screen window is smaller than the display area of the touch display unit, it is achieved that the first application is displayed on the touch display unit in non-full-screen window. The implementation of the non-full-screen window display will be described in detail later.

Step 102: parsing the first operation to obtain a first parsing result, the first parsing result indicating information for adjusting the first non-full-screen window.

The first parsing result indicates amplitude and a direction for scaling the first non-full-screen window and/or a distance and a direction for moving the first non-full-screen window by the first operation; or indicates that the first operation is an operation of closing the first non-full-screen window.

Step 103: determining a first transformation parameter in accordance with the first parsing result.

The first transformation parameter at least includes a parameter value, a matrix, a parameter group or a parameter set. In the case where the first transformation parameter is a matrix, for example, if the first transformation parameter indicates reducing the first non-full-screen window by 50% uniformly into a second non-full-screen window, a corresponding first matrix is

$$( \begin{matrix}1 / 2 & 0 & 0 \\ 0 & 1 / 2 & 0 \\ 0 & 0 & 1 / 2\end{matrix} ) ,$$

and a three-dimensional coordinate (xₜ, yₜ, zₜ) of a pixel point in the frame buffer data corresponding to the second non-full-screen window is shown in Equation (1):

$$( \begin{matrix}{x}_{t} , & {y}_{t} , & {z}_{t}\end{matrix} ) = ( \begin{matrix}1 / 2 & 0 & 0 \\ 0 & 1 / 2 & 0 \\ 0 & 0 & 1 / 2\end{matrix} ) \times ( \begin{matrix}{x}_{o} \\ {y}_{o} \\ {z}_{o}\end{matrix} ) . \qquad ( 1 )$$

Taking that first non-full-screen windows of an application 1 and an application 2 are transformed into second non-full-screen windows as an example, (xₒ, yₒ, zₒ) is a three-dimensional coordinate into which a two-dimensional coordinate (xₒ, yₒ) indicating a pixel point in the graphic buffer data of first non-full-screen windows of the application 1 and application 2 is extended, and graphic buffer data includes two-dimensional coordinate information and Red Green Blue (RGB) three-color information of a pixel point. Taking the case into consideration that there may be an overlapping region between the second non-full-screen window of the application 1 and the second non-full-screen window of the application 2, as shown in FIG. 1b, there is an overlapping region between the second non-full-screen window 1 and the second non-full-screen window 2. Correspondingly, in the embodiment, the two-dimensional coordinate (xₒ, yₒ) indicating a pixel point in the graphic buffer data of first non-full-screen windows of the application 1 and application 2 is extended into the three-dimensional coordinate (xₒ, yₒ, zₒ), the different second non-full-screen windows having different third-dimensional coordinate zₒ. Therefore, second non-full-screen windows of the application 1 and application 2 may be distinguished from each other by different third-dimensional coordinates, so as to determine the overlaying relationship of the overlapping region between the display area of the second non-full-screen window of the application 1 and that of the application 2. For example, in the case where there is an overlapping region between the second non-full-screen window 1 of the application 1 and the second non-full-screen window 2 of the application 2, a partial display area indicating the second non-full-screen window 1 is overlaid by the second non-full-screen window 2, and the overlapping region between the second non-full-screen window 1 and the second non-full-screen window 2 is used for displaying the application 2 if the third-dimensional coordinate of the second non-full-screen window 2 is far away from the origin with respect to the third-dimensional coordinate of the second non-full-screen window 1.

For example, in the case where the first transformation parameter indicates reducing the first non-full-screen window by 50% uniformly into a second non-full-screen window and moving the second non-full-screen window laterally by Δx and longitudinally by Δy, a corresponding first matrix is

$$( \begin{matrix}1 / 2 & 0 & Δ x \\ 0 & 1 / 2 & Δ y \\ 0 & 0 & 1 / 2\end{matrix} ) ,$$

and the three-dimensional coordinate (xₜ, yₜ, zₜ) of a pixel point in the frame buffer data corresponding to the second non-full-screen window is shown in Equation (2):

$$( \begin{matrix}{x}_{t} , & {y}_{t} , & {z}_{t}\end{matrix} ) = ( \begin{matrix}1 / 2 & 0 & Δ x \\ 0 & 1 / 2 & Δ y \\ 0 & 0 & 1 / 2\end{matrix} ) \times ( \begin{matrix}{x}_{o} \\ {y}_{o} \\ {z}_{o}\end{matrix} ) . \qquad ( 2 )$$

For example, in the case where the first transformation parameter indicates reducing the first non-full-screen window by 50% uniformly into a second non-full-screen window and rotating clockwise the second non-full-screen window by an angle θ, a corresponding first matrix is

$$( \begin{matrix}cos θ / 2 & sin θ / 2 & 0 \\ - sin θ / 2 & cos θ / 2 & 0 \\ 0 & 0 & 1 / 2\end{matrix} ) ,$$

and the three-dimensional coordinate (xₜ, yₜ, zₜ) of a pixel point in the frame buffer data corresponding to the second non-full-screen window is shown in Equation (3):

$$( \begin{matrix}{x}_{t} , & {y}_{t} , & {z}_{t}\end{matrix} ) = ( \begin{matrix}cos θ / 2 & sin θ / 2 & 0 \\ - sin θ / 2 & cos θ / 2 & 0 \\ 0 & 0 & 1 / 2\end{matrix} ) \times ( \begin{matrix}{x}_{o} \\ {y}_{o} \\ {z}_{o}\end{matrix} ) . \qquad ( 3 )$$

Step 104: transforming the first non-full-screen window by using the first transformation parameter to determine a second non-full-screen window for replacing the first non-full-screen window such that the first application is displayed within the second non-full-screen window.

In a optional embodiment of the step 104, the step 104 includes:

reading graphic buffer data of the first application;

converting the read graphic buffer data into graphic buffer data corresponding to the second non-full-screen window by using the first transformation parameter, and combining the graphic buffer data of the second non-full-screen window into frame buffer data corresponding to the touch display unit; and

displaying the second non-full-screen window of the first application on the touch display unit by using the frame buffer data, the second non-full-screen window being used for replacing the first non-full-screen window such that the first application is displayed within the corresponding second non-full-screen window.

It should be noted that, in the case where the first application is displayed in the first non-full-screen window for the first time, the determining manner of the first non-full-screen window is the same as that of the second non-full-screen window, and therefore is not described here again.

In the embodiment, in the case where the first application is displayed in the first non-full-screen window, a management operation of a user for the first non-full-screen window are received by a virtual function key in the second function area, and the first transformation parameter is determined in accordance with the parsed first parsing result. Thus a transformation such as moving and scaling may be performed on the first non-full-screen window and the management of the non-full-screen window may be achieved quickly and conveniently. So the operation is quick and convenient, and user experience is improved.

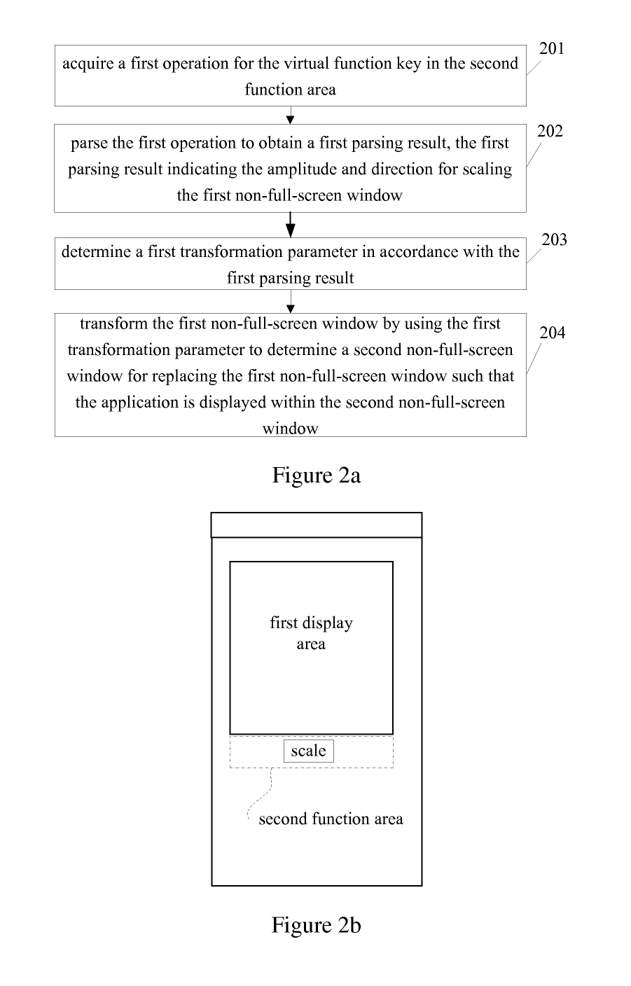

In an embodiment of the disclosure, it is provided a method for information processing. The method for information processing is applied to an electronic apparatus with a touch display unit, wherein M application identifiers one-to-one corresponding to M applications and a first non-full-screen window including a first display area and a second function area are displayed on the touch display unit, M being a positive integer; the first display area is used for displaying a first application, and the second function area includes at least one virtual function key, the first non-full-screen window is smaller than the display area of the touch display unit. FIG. 2a is a schematic flow chart of a method for information processing according to an embodiment of the disclosure, and as shown in FIG. 2a, the method includes steps 201 to 204.

Step 201: acquiring a first operation for the virtual function key in the second function area.

Since the first non-full-screen window is smaller than the display area of the touch display unit, it is achieved that the first application is displayed on the touch display unit in non-full-screen window. The implementation of the non-full-screen window display will be described in detail later.

Step 202: parsing the first operation to obtain a first parsing result, the first parsing result indicating amplitude and a direction for scaling the first non-full-screen window.

The first parsing result corresponds to an operation of scaling the first non-full-screen window, and the virtual function key corresponding to the scaling is shown in FIG. 2b. The scaling of the first non-full-screen window may be achieved by performing a drag-and-drop operation on the virtual function key corresponding to the scaling, and accordingly the amplitude and direction parameter information of the scaling are obtained by parsing the first operation for the virtual function key corresponding to the scaling.

Step 203: determining a first transformation parameter according to the first parsing result.

The first transformation parameter at least includes a parameter value, a matrix, a parameter group and a parameter set. In the case where the first transformation parameter is a matrix, taking that the first non-full-screen window is reduced by 50% uniformly into a second non-full-screen window as an example, a corresponding first matrix is

$$( \begin{matrix}1 / 2 & 0 & 0 \\ 0 & 1 / 2 & 0 \\ 0 & 0 & 1 / 2\end{matrix} ) ,$$

and the three-dimensional coordinate (xₜ, yₜ, zₜ) of a pixel point in the frame buffer data corresponding to the second non-full-screen window is shown in Equation (4):

$$( \begin{matrix}{x}_{t} , & {y}_{t} , & {z}_{t}\end{matrix} ) = ( \begin{matrix}1 / 2 & 0 & 0 \\ 0 & 1 / 2 & 0 \\ 0 & 0 & 1 / 2\end{matrix} ) \times ( \begin{matrix}{x}_{o} \\ {y}_{o} \\ {z}_{o}\end{matrix} ) . \qquad ( 4 )$$

Taking that first non-full-screen windows of an application 1 and an application 2 are transformed into second non-full-screen windows as an example, (xₒ, yₒ, zₒ) is a three-dimensional coordinate into which a two-dimensional coordinate (xₒ, yₒ) indicating a pixel point in the graphic buffer data of first non-full-screen windows of the application 1 and application 2 is extended, and the graphic buffer data includes two-dimensional coordinate information and RGB three-color information of a pixel point. Taking the case into consideration that there may be an overlapping region between the second non-full-screen window of the application 1 and the second non-full-screen window of the application 2, as shown in FIG. 1b, there is an overlapping region between the second non-full-screen window 1 and the second non-full-screen window 2. Correspondingly, in the embodiment, the two-dimensional coordinate (xₒ, yₒ) indicating a pixel point in the graphic buffer data of first non-full-screen windows of the application 1 and application 2 is extended into the three-dimensional coordinate (xₒ, yₒ, zₒ), the different second non-full-screen windows having different third-dimensional coordinate zₒ. Therefore, second non-full-screen windows of the application 1 and application 2 may be distinguished from each other by different third-dimensional coordinates, so as to determine the overlaying relationship of the overlapping region between the display area of the second non-full-screen window of the application 1 and that of the application 2. For example, in the case where there is an overlapping region between the second non-full-screen window 1 of the application 1 and the second non-full-screen window 2 of the application 2, a partial display area indicating the second non-full-screen window 1 is overlaid by the second non-full-screen window 2, and the overlapping region between the second non-full-screen window 1 and the second non-full-screen window 2 is used for displaying the application 2 if the third-dimensional coordinate of the second non-full-screen window 2 is far away from the origin with respect to the third-dimensional coordinate of the second non-full-screen window 1.

Taking that the second non-full-screen window is enlarged 150% uniformly into a new second non-full-screen window as an example, a corresponding first matrix is

$$( \begin{matrix}3 / 2 & 0 & 0 \\ 0 & 3 / 2 & 0 \\ 0 & 0 & 3 / 2\end{matrix} ) ,$$

and the three-dimensional coordinate (xₜ, yₜ, zₜ) of a pixel point of the frame buffer data corresponding to the second non-full-screen window is shown as Equation (5):

$$( \begin{matrix}{x}_{t} , & {y}_{t} , & {z}_{t}\end{matrix} ) = ( \begin{matrix}3 / 2 & 0 & 0 \\ 0 & 3 / 2 & 0 \\ 0 & 0 & 3 / 2\end{matrix} ) \times ( \begin{matrix}{x}_{o} \\ {y}_{o} \\ {z}_{o}\end{matrix} ) \qquad ( 5 )$$

Step 204: transforming the first non-full-screen window by using the first transformation parameter to determine a second non-full-screen window for replacing the first non-full-screen window such that the first application is displayed within the second non-full-screen window.

In a optional embodiment of the step 204, the step 204 includes:

reading graphic buffer data of the first application;

converting the read graphic buffer data into graphic buffer data corresponding to the second non-full-screen window by using the first transformation parameter, and combining the graphic buffer data of the second non-full-screen window into frame buffer data corresponding to the touch display unit; and

displaying the second non-full-screen window of the first application on the touch display unit by using the frame buffer data, the second non-full-screen window being used for replacing the first non-full-screen window such that the first application is displayed within the corresponding second non-full-screen window.

It should be noted that, in the case where the first application is displayed in the first non-full-screen window for the first time, the determining manner of the first non-full-screen window is the same as that of the second non-full-screen window, and therefore is not described here again.

In the embodiment, in the case where the first application is displayed in the first non-full-screen window, a management operation of a user for the first non-full-screen window are received by a virtual function key in the second function area, and the first transformation parameter is determined in accordance with the parsed first parsing result. Thus the scaling transformation may be performed on the first non-full-screen window and the management of the non-full-screen window may be achieved quickly and conveniently. So the operation is quick and convenient, and user experience is improved.

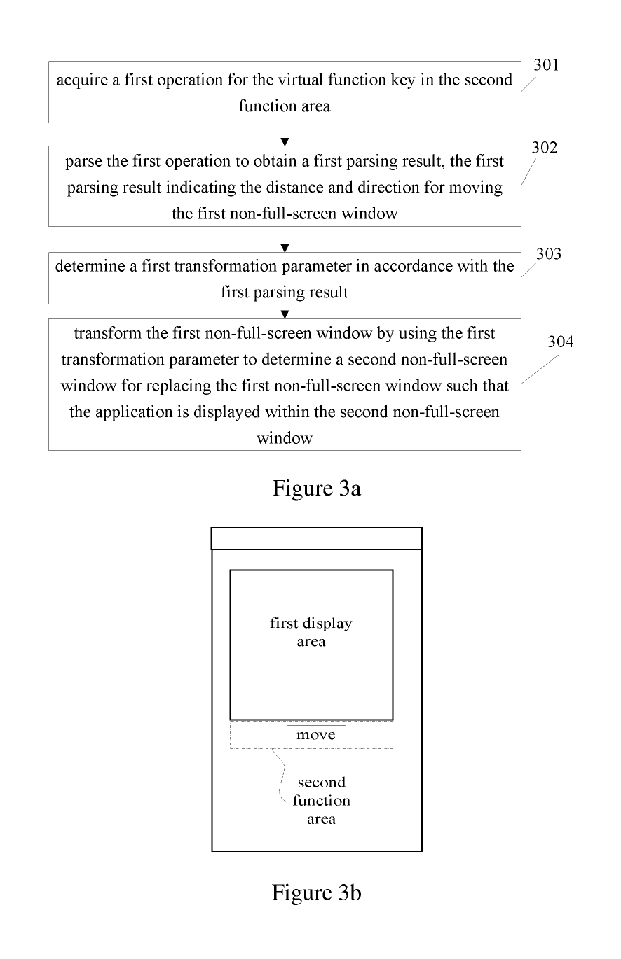

In an embodiment of the disclosure, it is provided a method for information processing. The method for information processing is applied to an electronic apparatus with a touch display unit, wherein M application identifiers one-to-one corresponding to M applications and a first non-full-screen window including a first display area and a second function area are displayed on the touch display unit, M being a positive integer; the first display area is used for displaying a first application, and the second function area includes at least one virtual function key, the first non-full-screen window is smaller than the display area of the touch display unit. FIG. 3a is a schematic flow chart of a method for information processing according to an embodiment of the disclosure, and as shown in FIG. 3a, the method includes steps 301 to 304.

Step 301: acquiring a first operation for the virtual function key in the second function area.

Since the first non-full-screen window is smaller than the display area of the touch display unit, it is achieved that the first application is displayed on the touch display unit in non-full-screen window. The implementation of the non-full-screen window display will be described in detail later.

Step 302: parsing the first operation to obtain a first parsing result, the first parsing result indicating amplitude and a direction for moving the first non-full-screen window.

The first parsing result corresponds to an operation for moving the first non-full-screen window, and the virtual function key corresponding to the moving is shown in FIG. 3b. The amplitude and direction parameter information of the moving are obtained by parsing the first operation for the virtual function key corresponding to the moving.

Step 303: determining a first transformation parameter in accordance with the first parsing result.

The first transformation parameter at least includes a parameter value, a matrix, a parameter group or a parameter set. In the case where the first transformation parameter is a matrix, taking that the first non-full-screen window is moved laterally by Δx and longitudinally by Δy as an example, a corresponding first matrix is

$$( \begin{matrix}1 & 0 & Δ x \\ 0 & 1 & Δ y \\ 0 & 0 & 1\end{matrix} ) ,$$

and the three-dimensional coordinate (xₜ, yₜ, zₜ) of a pixel point in the frame buffer data corresponding to the second non-full-screen window is shown in Equation (6):

$$( \begin{matrix}{x}_{t} , & {y}_{t} , & {z}_{t}\end{matrix} ) = ( \begin{matrix}1 & 0 & Δ x \\ 0 & 1 & Δ y \\ 0 & 0 & 1\end{matrix} ) \times ( \begin{matrix}{x}_{o} \\ {y}_{o} \\ {z}_{o}\end{matrix} ) . \qquad ( 6 )$$

Taking that first non-full-screen windows of an application 1 and an application 2 are transformed into second non-full-screen windows as an example, (xₒ, yₒ, zₒ) is a three-dimensional coordinate into which a two-dimensional coordinate (xₒ, yₒ) indicating a pixel point in the graphic buffer data of first non-full-screen windows of the application 1 and application 2 is extended, and graphic buffer data includes two-dimensional coordinate information and Red Green Blue (RGB) three-color information of a pixel point. Taking the case into consideration that there may be an overlapping region between the second non-full-screen window of the application 1 and the second non-full-screen window of the application 2, as shown in FIG. 1b, there is an overlapping region between the second non-full-screen window 1 and the second non-full-screen window 2. Correspondingly, in the embodiment, the two-dimensional coordinate (xₒ, yₒ) indicating a pixel point in the graphic buffer data of first non-full-screen windows of the application 1 and application 2 is extended into the three-dimensional coordinate (xₒ, yₒ, zₒ), the different second non-full-screen windows having different third-dimensional coordinate zₒ. Therefore, second non-full-screen windows of the application 1 and application 2 may be distinguished from each other by different third-dimensional coordinates, so as to determine the overlaying relationship of the overlapping region between the display area of the second non-full-screen window of the application 1 and that of the application 2. For example, in the case where there is an overlapping region between the second non-full-screen window 1 of the application 1 and the second non-full-screen window 2 of the application 2, a partial display area indicating the second non-full-screen window 1 is overlaid by the second non-full-screen window 2, and the overlapping region between the second non-full-screen window 1 and the second non-full-screen window 2 is used for displaying the application 2 if the third-dimensional coordinate of the second non-full-screen window 2 is far away from the origin with respect to the third-dimensional coordinate of the second non-full-screen window 1.

Step 304: transforming the first non-full-screen window by using the first transformation parameter to determine a second non-full-screen window for replacing the first non-full-screen window such that the first application is displayed within the second non-full-screen window.

In a optional embodiment of the step 304, the step 304 includes:

reading graphic buffer data of the first application;

converting the read graphic buffer data into graphic buffer data corresponding to the second non-full-screen window by using the first transformation parameter, and combining the graphic buffer data of the second non-full-screen window into frame buffer data corresponding to the touch display unit; and

displaying the second non-full-screen window of the first application on the touch display unit by using the frame buffer data, the second non-full-screen window being used for replacing the first non-full-screen window such that the first application is displayed within the corresponding second non-full-screen window.

It should be noted that, in the case where the first application is displayed in the first non-full-screen window for the first time, the determining manner of the first non-full-screen window is the same as that of the second non-full-screen window, and therefore is not described here again.

In the embodiment, when the first application is displayed in the first non-full-screen window, i.e., in non-full-screen window, an operation of a user for moving the first non-full-screen window is received by a virtual function key in the second function area, and the first transformation parameter is determined in accordance with the parsed first parsing result. Thus the moving operation may be performed on the first non-full-screen window, and the management of the non-full-screen window may be achieved quickly and conveniently. So the operation is quick and convenient, and improves user experience.

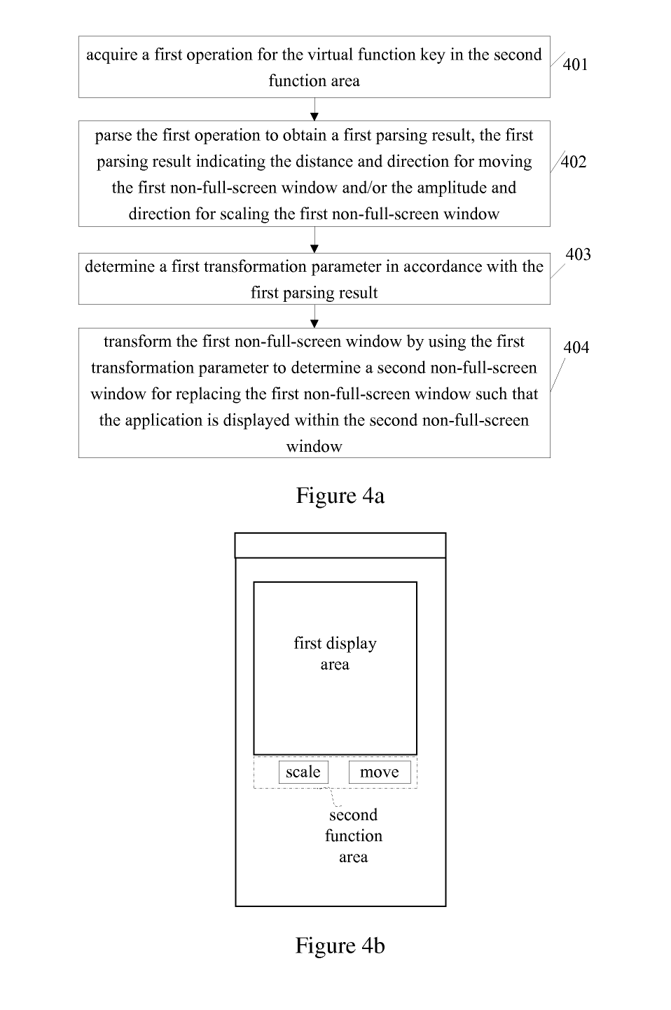

In an embodiment of the disclosure, it is provided a method for information processing. The method for information processing is applied to an electronic apparatus with a touch display unit, wherein M application identifiers one-to-one corresponding to M applications and a first non-full-screen window including a first display area and a second function area are displayed on the touch display unit, M being a positive integer; the first display area is used for displaying a first application, and the second function area includes at least one virtual function key, the first non-full-screen window is smaller than the display area of the touch display unit. FIG. 4a is a schematic flow chart of a method for information processing according to an embodiment of the disclosure, and as shown in FIG. 4a, the method includes steps 401 to 404.

Step 401: acquiring a first operation for the virtual function key in the second function area.

Since the first non-full-screen window is smaller than the display area of the touch display unit, it is achieved that the first application is displayed on the touch display unit in non-full-screen window. The implementation of the non-full-screen window display will be described in detail later.

Step 402: parsing the first operation to obtain a first parsing result, the first parsing result indicating a distance and a direction for moving the first non-full-screen window and/or an amplitude and a direction for scaling the first non-full-screen window.

The first parsing result corresponds to an operation of moving and scaling the first non-full-screen window. As shown in FIG. 4b, the amplitude and direction parameter information of the moving and the amplitude and direction parameter information of the scaling are obtained by parsing the first operation for the virtual function key.

Step 403: determining a first transformation parameter in accordance with the first parsing result.

The first transformation parameter at least includes a parameter value, a matrix, a parameter group and a parameter set. In the case where the first transformation parameter is a matrix, the first parsing result indicating the distance and direction for moving the first non-full-screen window and/or the amplitude and direction for scaling the first non-full-screen window, taking that the first non-full-screen window is reduced by 50% uniformly into a second function area and the second function area is moved laterally by Δx and longitudinally by Δy as an example below, a corresponding first matrix is

$$( \begin{matrix}1 / 2 & 0 & Δ x \\ 0 & 1 / 2 & Δ y \\ 0 & 0 & 1 / 2\end{matrix} ) ,$$

and the three-dimensional coordinate (xₜ, yₜ, zₜ) of a pixel point in the frame buffer data corresponding to the second non-full-screen window is shown in Equation (7):

$$( {x}_{t} , {y}_{t} , {z}_{t} ) = ( \begin{matrix}1 / 2 & 0 & Δ x \\ 0 & 1 / 2 & Δ y \\ 0 & 0 & 1 / 2\end{matrix} ) \times ( \begin{matrix}{x}_{o} \\ {y}_{o} \\ {z}_{o}\end{matrix} ) . \qquad ( 7 )$$

Taking that first non-full-screen windows of an application 1 and an application 2 are transformed into second non-full-screen windows as an example, (xₒ, yₒ, zₒ) is a three-dimensional coordinate into which a two-dimensional coordinate (xₒ, yₒ) indicating a pixel point in the graphic buffer data of first non-full-screen windows of the application 1 and application 2 is extended, and graphic buffer data includes two-dimensional coordinate information and Red Green Blue (RGB) three-color information of a pixel point. Taking the case into consideration that there may be an overlapping region between the second non-full-screen window of the application 1 and the second non-full-screen window of the application 2, as shown in FIG. 1b, there is an overlapping region between the second non-full-screen window 1 and the second non-full-screen window 2. Correspondingly, in the embodiment, the two-dimensional coordinate (xₒ, yₒ) indicating a pixel point in the graphic buffer data of first non-full-screen windows of the application 1 and application 2 is extended into the three-dimensional coordinate (xₒ, yₒ, zₒ), the different second non-full-screen windows having different third-dimensional coordinate zₒ. Therefore, second non-full-screen windows of the application 1 and application 2 may be distinguished from each other by different third-dimensional coordinates, so as to determine the overlaying relationship of the overlapping region between the display area of the second non-full-screen window of the application 1 and that of the application 2. For example, in the case where there is an overlapping region between the second non-full-screen window 1 of the application 1 and the second non-full-screen window 2 of the application 2, a partial display area indicating the second non-full-screen window 1 is overlaid by the second non-full-screen window 2, and the overlapping region between the second non-full-screen window 1 and the second non-full-screen window 2 is used for displaying the application 2 if the third-dimensional coordinate of the second non-full-screen window 2 is far away from the origin with respect to the third-dimensional coordinate of the second non-full-screen window 1.

Step 404: transforming the first non-full-screen window by using the first transformation parameter to determine a second non-full-screen window for replacing the first non-full-screen window such that the first application is displayed within the second non-full-screen window.

In a optional embodiment of the step 404, the step 404 includes:

reading graphic buffer data of the first application;

converting the read graphic buffer data into graphic buffer data corresponding to the second non-full-screen window by using the first transformation parameter, and combining the graphic buffer data of the second non-full-screen window into frame buffer data corresponding to the touch display unit; and

displaying the second non-full-screen window of the first application on the touch display unit by using the frame buffer data, the second non-full-screen window being used for replacing the first non-full-screen window such that the first application is displayed within the corresponding second non-full-screen window.

It should be noted that, in the case where the first application is displayed in the first non-full-screen window for the first time, the determining manner of the first non-full-screen window is the same as that of the second non-full-screen window, and therefore is not described here again.

In the embodiment, in the case where the first application is displayed in the first non-full-screen window, a management operation of a user for the first non-full-screen window are received by a virtual function key in the second function area, and the first transformation parameter is determined in accordance with the parsed first parsing result. Thus the moving and/or scaling operation may be performed on the first non-full-screen window. So the operation is quick and convenient, and user experience is improved.

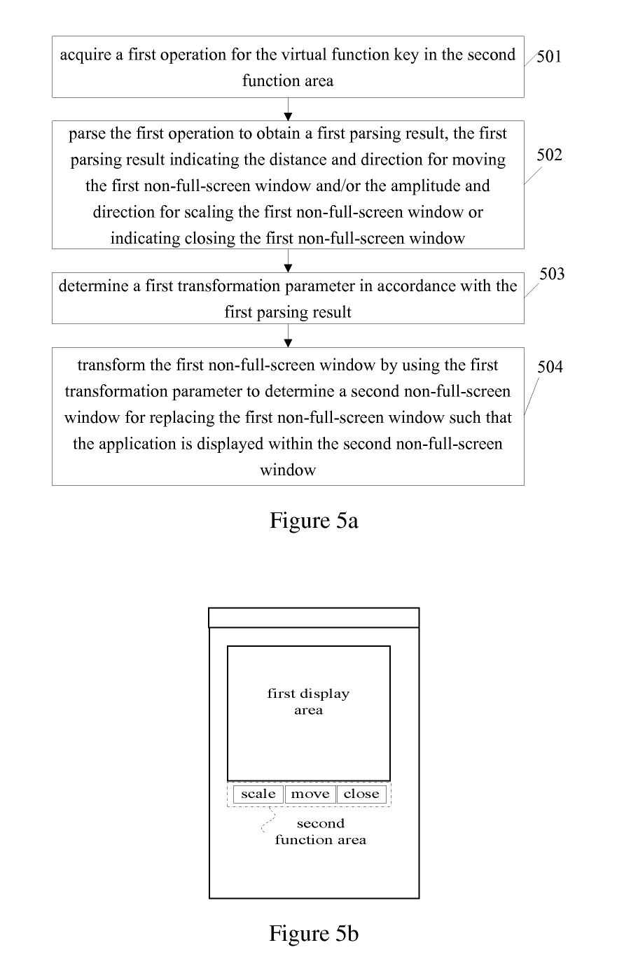

In an embodiment of the disclosure, it is provided a method for information processing. The method for information processing is applied to an electronic apparatus with a touch display unit, wherein M application identifiers one-to-one corresponding to M applications and a first non-full-screen window including a first display area and a second function area are displayed on the touch display unit, M being a positive integer; the first display area is used for displaying a first application, and the second function area includes at least one virtual function key, the first non-full-screen window is smaller than the display area of the touch display unit. FIG. 5a is a schematic flow chart of a method for information processing according to an embodiment of the disclosure, and as shown in FIG. 5a, the method includes steps 501 to 504.

Step 501: acquiring a first operation for the virtual function key in the second function area.

Since the first non-full-screen window is smaller than the display area of the touch display unit, it is achieved that the first application is displayed on the touch display unit in non-full-screen window. The implementation of the non-full-screen window display will be described in detail later.

Step 502: parsing the first operation to obtain a first parsing result, the first parsing result indicating a distance and a direction for moving the first non-full-screen window and/or an amplitude and a direction for scaling the first non-full-screen window, or indicating closing the first non-full-screen window.

As shown in FIG. 5b, by parsing the first operation for the virtual function key, the distance and direction information of the corresponding moving and/or the amplitude and direction information of the scaling are obtained, or the information for closing the first non-full-screen window is obtained.

Step 503: determining a first transformation parameter in accordance with the first parsing result.

The first parsing result indicates the distance and direction for moving the first non-full-screen window and/or the amplitude and direction of the scaling; or indicates closing the first non-full-screen window. Accordingly, in the case where the information indicating closing the first non-full-screen window is obtained in the step 502, the first non-full-screen window is closed and the process is stopped.

That the first parsing result indicates the distance and direction for moving the first non-full-screen window and that the first parsing result indicates the amplitude and direction of the scaling are described below respectively. For example, in the case where the first parsing result indicates that the first non-full-screen window is reduced by 50% uniformly into the second function area and the second function area is moved laterally by Δx and longitudinally by Δy, a corresponding first matrix is

$$( \begin{matrix}1 / 2 & 0 & Δ x \\ 0 & 1 / 2 & Δ y \\ 0 & 0 & 1 / 2\end{matrix} ) ,$$

and the three-dimensional coordinate (xₜ, yₜ, zₜ) of a pixel point in the frame buffer data corresponding to the second non-full-screen window is shown in Equation (8):

$$( {x}_{t} , {y}_{t} , {z}_{t} ) = ( \begin{matrix}1 / 2 & 0 & Δ x \\ 0 & 1 / 2 & Δ y \\ 0 & 0 & 1 / 2\end{matrix} ) \times ( \begin{matrix}{x}_{o} \\ {y}_{o} \\ {z}_{o}\end{matrix} ) . \qquad ( 8 )$$

Taking that first non-full-screen windows of an application 1 and an application 2 are transformed into second non-full-screen windows as an example, (xₒ, yₒ, zₒ) is a three-dimensional coordinate into which a two-dimensional coordinate (xₒ, yₒ) indicating a pixel point in the graphic buffer data of first non-full-screen windows of the application 1 and application 2 is extended, and graphic buffer data includes two-dimensional coordinate information and Red Green Blue (RGB) three-color information of a pixel point. Taking the case into consideration that there may be an overlapping region between the second non-full-screen window of the application 1 and the second non-full-screen window of the application 2, as shown in FIG. 1b, there is an overlapping region between the second non-full-screen window 1 and the second non-full-screen window 2. Correspondingly, in the embodiment, the two-dimensional coordinate (xₒ, yₒ) indicating a pixel point in the graphic buffer data of first non-full-screen windows of the application 1 and application 2 is extended into the three-dimensional coordinate (xₒ, yₒ, zₒ), the different second non-full-screen windows having different third-dimensional coordinate zₒ. Therefore, second non-full-screen windows of the application 1 and application 2 may be distinguished from each other by different third-dimensional coordinates, so as to determine the overlaying relationship of the overlapping region between the display area of the second non-full-screen window of the application 1 and that of the application 2. For example, in the case where there is an overlapping region between the second non-full-screen window 1 of the application 1 and the second non-full-screen window 2 of the application 2, a partial display area indicating the second non-full-screen window 1 is overlaid by the second non-full-screen window 2, and the overlapping region between the second non-full-screen window 1 and the second non-full-screen window 2 is used for displaying the application 2 if the third-dimensional coordinate of the second non-full-screen window 2 is far away from the origin with respect to the third-dimensional coordinate of the second non-full-screen window 1.

Step 504: transforming the first non-full-screen window by using the first transformation parameter to determine a second non-full-screen window for replacing the first non-full-screen window such that the first application is displayed within the second non-full-screen window.

In a optional embodiment of the step 504, the step 504 includes:

reading graphic buffer data of the first application;

converting the read graphic buffer data into graphic buffer data corresponding to the second non-full-screen window by using the first transformation parameter, and combining the graphic buffer data of the second non-full-screen window into frame buffer data corresponding to the touch display unit; and

displaying the second non-full-screen window of the first application on the touch display unit by using the frame buffer data, the second non-full-screen window being used for replacing the first non-full-screen window such that the first application is displayed within the corresponding second non-full-screen window.

It should be noted that, in the case where the first application is displayed in the first non-full-screen window for the first time, the determining manner of the first non-full-screen window is the same as that of the second non-full-screen window, and therefore is not described here again.

In the embodiment, in the case where the first application is displayed in the first non-full-screen window, a management operation of a user for the first non-full-screen window are received by a virtual function key in the second function area, and the first transformation parameter is determined in accordance with the parsed first parsing result. Thus the moving and/or scaling operation or the closing operation may be performed on the first non-full-screen window. So the operation is quick and convenient, and user experience is improved.

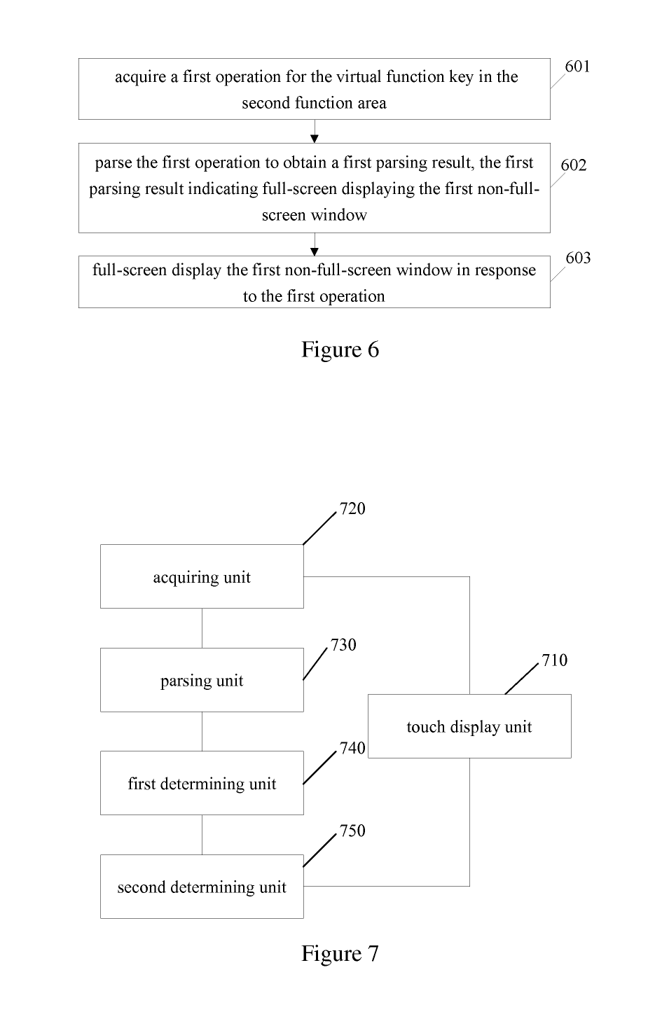

In an embodiment of the disclosure, it is provided a method for information processing. The method for information processing is applied to an electronic apparatus with a touch display unit, wherein M application identifiers one-to-one corresponding to M applications and a first non-full-screen window including a first display area and a second function area are displayed on the touch display unit, M being a positive integer; the first display area is used for displaying a first application, and the second function area includes at least one virtual function key, the first non-full-screen window is smaller than the display area of the touch display unit. FIG. 6a is a schematic flow chart of an method for information processing according to an embodiment of the disclosure, and as shown in FIG. 6a, the method includes steps 601 to 604.

Step 601: acquiring a first operation for the virtual function key in the second function area.

Step 602: parsing the first operation to obtain a first parsing result, the first parsing result indicating displaying full-screen the first non-full-screen window.

Step 603: displaying full-screen the first non-full-screen window in response to the first operation.

It should be noted that, in the case where the first application is displayed in the first non-full-screen window for the first time, the determining manner of the first non-full-screen window is the same as that of the second non-full-screen window, and therefore is not described here again.

In the embodiment, in the case where an electronic apparatus displays the first application in the first non-full-screen window, if it receives a first operation for the second function area indicating displaying full-screen the first non-full-screen window from a user of the electronic apparatus, the electronic apparatus displays full-screen the first non-full-screen window, thus the electronic apparatus is enable to switch a non-full-screen window into a full-screen window quickly and conveniently. So the operation is quick and convenient, and user experience is improved.

It to be noted that, the virtual function key in the embodiment may be the same key as the virtual function key indicative of closing the first non-full-screen window as described in the embodiment shown in FIG. 5b. Specifically, different forms of first operations implemented for the virtual function key are associated with an operation of closing the first operation, an operation of full-screen displaying the first non-full-screen window respectively. Different forms of first operations implemented for the virtual function key include: a first operation of implementing different contacts, a first operation of implementing the virtual function key for different durations.

Thus, operations of full-screen displaying or closing the first non-full-screen window may be achieved by the same virtual function key, therefore, the area of the touch display unit occupied is saved, and it is convenient for a user of an electronic apparatus to operate.

It to be noted that, the description of the embodiments of an electronic apparatus below is similar to the description of the above method, the beneficial effects thereof are the same as these of the method, and are not described again. Please refer to the description of the embodiments of the method of the disclosure for the technical details not disclosed in the description of the embodiments of an electronic apparatus.

In an embodiment of the disclosure, an electronic apparatus is provided. As shown in FIG. 7, the electronic apparatus includes a touch display unit 710. M application identifiers one-to-one corresponding to M applications and a first non-full-screen window including a first display area and a second function area are displayed on the touch display unit 710, M being a positive integer. The first display area is used for display a first application, and the second function area includes at least one virtual function key, the first non-full-screen window being smaller than the display area of the touch display unit 710. The electronic apparatus further includes an acquiring unit 720, a parsing unit 730, a first determining unit 740 and a second determining unit 750.

The acquiring unit 720 is configured to acquire a first operation for the virtual function key in the second function area.

The parsing unit 730 is configured to parse the first operation to obtain a first parsing result, the first parsing result indicating information for adjusting the first non-full-screen window.

The first determining unit 740 is configured to determine a first transformation parameter in accordance with the first parsing result.

The second determining unit 750 is configured to transform the first non-full-screen window by using the first transformation parameter to determine a second non-full-screen window for replacing the first non-full-screen window such that the first application is displayed within the second non-full-screen window.

The first transformation parameter at least includes a parameter value, a matrix, a parameter group or a parameter set.

In practice, the touch display unit 710 may be implemented by a touch display screen and related circuits in the electronic apparatus; each of the acquiring unit 720, the paring unit 730, the first determining unit 740 and the second determining unit 750 may be implemented by a CPU, Digital Signal Processor(DSP) or Field Programmable Gate Array (FPGA) in the electronic apparatus; the touch display unit 710 may be implemented by a touch displayer in the electronic apparatus.

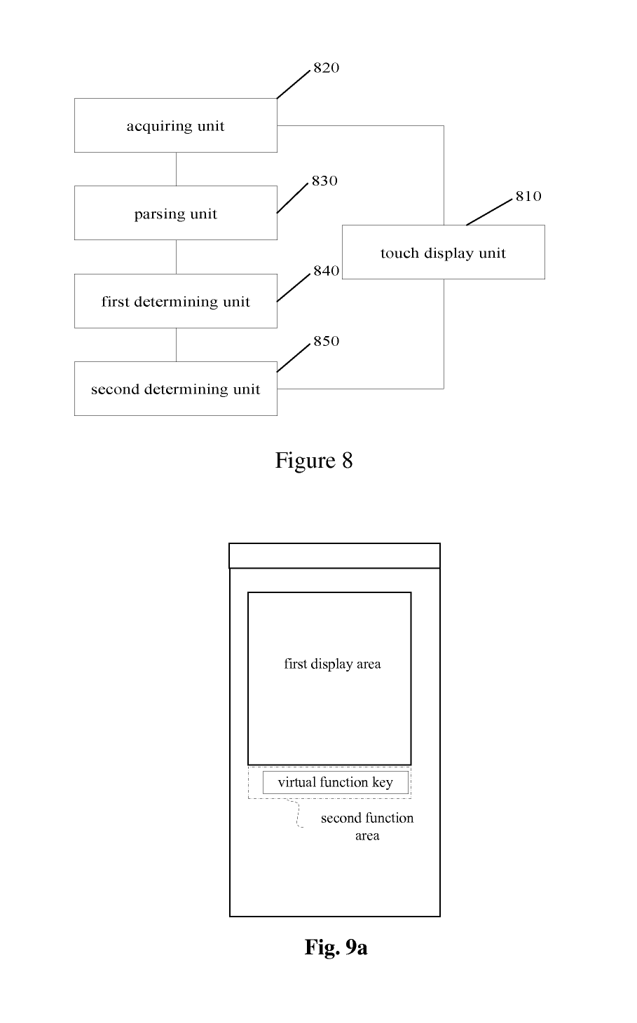

In an embodiment of the disclosure, an electronic apparatus is provided. As shown in FIG. 8, the electronic apparatus includes a touch display unit 810. M application identifiers one-to-one corresponding to M applications and a first non-full-screen window including a first display area and a second function area are displayed on the touch display unit 810, M being a positive integer. The first display area is used for displaying a first application, and the second function area includes at least one virtual function key, the first non-full-screen window being smaller than the display area of the touch display unit 810. The electronic apparatus further includes an acquiring unit 820, a parsing unit 830, a first determining unit 840 and a second determining unit 850.

The acquiring unit 820 is configured to acquire a first operation for the virtual function key in the second function area.

The parsing unit 830 is configured to parse the first operation to obtain a first parsing result, the first parsing result indicating information for adjusting the first non-full-screen window.

The first determining unit 840 is configured to determine a first transformation parameter in accordance with the first parsing result.

The second determining unit 850 is configured to transform the first non-full-screen window by using the first transformation parameter to determine a second non-full-screen window for replacing the first non-full-screen window such that the first application is displayed within the second non-full-screen window.

The touch display unit 810 is further configured to display, on the second function area, a first virtual function key indicative of moving the first non-full-screen window and/or a second virtual function key indicative of scaling the first non-full-screen window.

The first determining unit 840 is further configured to determine the first transformation parameter in accordance with a distance and a direction of the movement of the first non-full-screen window and/or an amplitude and a direction of the scaling of the first non-full-screen window indicated by the first parsing result in the case where the operation object of the first operation is the first virtual function key.

The touch display unit 810 is further configured to display, on the second function area, a third virtual function key indicative of closing the first non-full-screen window.

The acquiring unit 820 is further configured to acquire the first operation for the third virtual function key in the second function area.

The touch display unit 810 is further configured to close the first non-full-screen window displayed on the touch display unit in response to the first operation for the third virtual function key.

The first determining unit 840 is further configured to: read graphic buffer data of the first application;

convert the read graphic buffer data into graphic buffer data corresponding to the second non-full-screen window by using the first transformation parameter, and combine the graphic buffer data of the second non-full-screen window into frame buffer data corresponding to the touch display unit 810; and

display the second non-full-screen window of the first application on the touch display unit 810 by using the frame buffer data, the second non-full-screen window being used for replacing the first non-full-screen window such that the first application is displayed within the corresponding second non-full-screen window.

The first transformation parameter determined by the first determining unit 840 at least includes a parameter value, a matrix, a parameter group or a parameter set.

In practice, the touch display unit 810 may be implemented by a touch display screen and related circuits in the electronic apparatus; and each of the acquiring unit 820, the paring unit 830, the first determining unit 840 and the second determining unit 850 may all be implemented by a CPU, DSP or FPGA in the electronic apparatus.

An embodiment of the disclosure provides a method for information processing for an electronic apparatus with a touch display unit. In the case where a first application is run on the electronic apparatus, a first non-full-screen window with a first display area and a second function area is displayed on the touch display unit. As shown in FIG. 9a, the first display area is configured to display the first application, the second function area includes a virtual function key and the first non-full-screen window is smaller than a display area of the touch display unit. FIG. 9b is a flowchart for a method for information processing according to the embodiment of the disclosure. As shown in FIG. 9b, the method for information processing includes the following steps 901 to 906.

Step 901, acquiring a first operation.

Step 902, parsing the first operation to generate a first parsing result in the case where it is judged that an operating object of the first operation is the virtual function key.

Step 903, judging whether the first parsing result meets a first condition or a second condition; performing Step 904 in the case where the first parsing result meets the first condition; and performing Step 905 and Step 906 successively in the case where the first parsing result meets the second condition.

The first condition and the second condition may be determined according to a duration parameter of a first touch event triggered by the first operation, or may be determined according to a contact parameter of a touch event triggered by the first operation on the virtual function key. The first touch event is a touch event corresponding to the virtual function key which is triggered by the first operation; the duration parameter indicates the duration of the first touch event; and the contact parameter indicates the number of the contacts sensed by the touch display unit in a area corresponding to the virtual function key in the case where the first operation triggers the first touch event.

Step 904, displaying a third window for replacing the first non-full-screen window on the touch display unit to display the first application in the third window; the third window being different from the first non-full-screen window in response to the first operation. The third window may be obtained by transforming the first non-full-screen window by using a transformation parameter.

Step 905, determining a first transformation parameter in response to the first operation.

Step 906, transforming the first non-full-screen window into the second non-full-screen window by using the first transformation parameter to display the first application in a first display area of the second non-full-screen window; the second non-full-screen window being different from either of the first non-full-screen window or the third window.

According to a optional embodiment, transforming the first non-full-screen window into the second non-full-screen window by using the first transformation parameter may include:

reading graphic buffer data of the first application;

converting the read graphic buffer data into graphic buffer data of the second non-full-screen window, and combining the graphic buffer data of the second non-full-screen window into frame buffer data of touch display unit; and

displaying the second non-full-screen window for replacing the first non-full-screen window on the touch display unit by using the frame buffer data to display the first application in the second non-full-screen window.

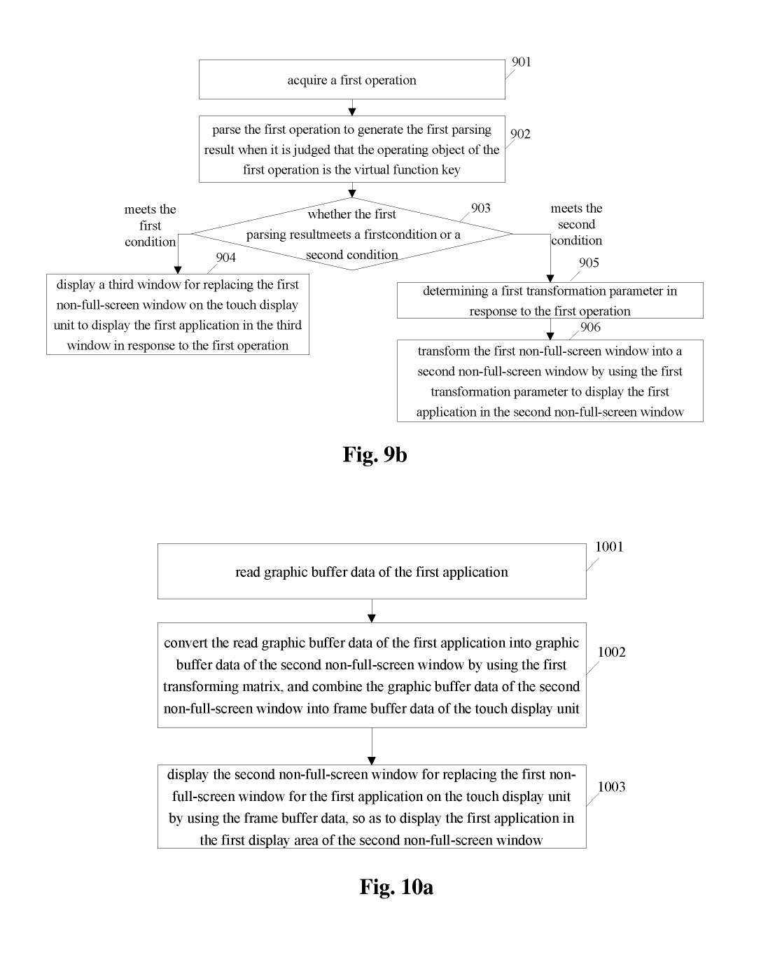

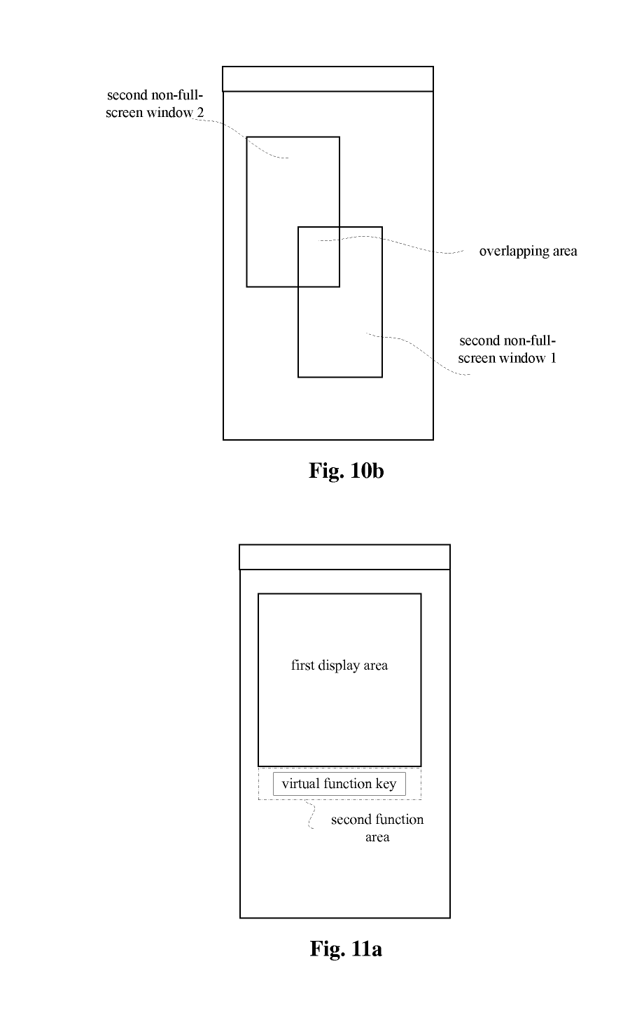

The first transformation parameter may at least include a parameter value, a matrix, a parameter group or a parameter set. In the case where the first transformation parameter is a matrix, displaying the first application in the second non-full-screen window, i.e., switching a state of displaying the first application on the first display area of the first non-full-screen window into a state of displaying the first application on the second non-full-screen window, will be described. As shown in FIG. 10a, the switching may include the following steps 1001 to 1003.

Step 1001, reading graphic buffer data of the first application.

The graphic buffer data of the first application which is plotted by the first application itself and used for full-screen displaying is written into a graphic buffer by the first application, i.e., the data is stored as graphic buffer data. The graphic buffer data may include two-dimension coordinates and Red, Green and Blue (RGB) information of a pixel point.

Step 1002, converting the read graphic buffer data of the first application into graphic buffer data of the second non-full-screen window by using the first transforming matrix, and combining the graphic buffer data of the second non-full-screen window into the frame buffer data of the touch display unit.

In the case where transforming first non-full-screen windows corresponding to more than one first applications into second non-full-screen windows, taking a first application 1 and a second application 2 as an example, the case that there may be an overlapping region between the second non-full-screen window of the application 1 and the second non-full-screen window of the application 2 is taken into consideration. As shown in FIG. 10b, there is an overlapping region between the second non-full-screen window 1 and the second non-full-screen window 2. Correspondingly, according to the embodiment, a two-dimension coordinates (x₀, y₀) indicating a pixel point in the graphic buffer data of first non-full-screen windows of the first application 1 and the first application 2, is extended into a three-dimension coordinates (x₀, y₀, z₀). The different non-full-screen windows have different third-dimension coordinates z₀. Therefore, the second non-full-screen window of the first application 1 and the second non-full-screen window of the first application 2 may be distinguished from each other by different third-dimension coordinates z₀ so as to determine the overlaying relationship of the overlapping area between the second non-full-screen window of the first application 1 and the second non-full-screen window of the first application 2. For example, in the case where there is an overlapping region between the second non-full-screen window 1 of the first application 1 and the second non-full-screen window 2 of the first application 2, the overlapping area between the second non-full-screen window 1 and the second non-full-screen window 2 is provided for displaying the first application 2 if the distance between the origin and the third-dimension coordinate of the second non-full-screen window 2 is greater than the distance between the origin and the third-dimension coordinate of second non-full-screen window 1 thus a part of the second non-full-screen window 1 is overlaid by the second non-full-screen window 2.

In related art, the graphic buffer data read in Step 1001 and graphic buffer data of the conventional first application (e.g., the status bar) in electronic apparatus may be combined into the frame buffer data as the content for full-screen displaying by the electronic apparatus. Therefore, according to the embodiment, the first non-full-screen window may be transformed into the second non-full-screen window though converting the extended three-dimension coordinates (x₀, y₀, z₀) in the graphic buffer data by using the first transforming matrix. The converted graphic buffer data may include the converted (x₀, y₀, z₀) and the RGB information of pixel points.

As for uniformly reducing the first non-full-screen window by 50% into the second non-full-screen window, a corresponding first transforming matrix is

$$( \begin{matrix}1 / 2 & 0 & 0 \\ 0 & 1 / 2 & 0 \\ 0 & 0 & 1 / 2\end{matrix} ) ,$$

and a three-dimension coordinates (xₜ, yₜ, zₜ) of a pixel point in the frame buffer data of the second non-full-screen window is shown in Equation (9):

$$( {x}_{t} , {y}_{t} , {z}_{t} ) = ( \begin{matrix}1 / 2 & 0 & 0 \\ 0 & 1 / 2 & 0 \\ 0 & 0 & 1 / 2\end{matrix} ) \times ( \begin{matrix}{x}_{o} \\ {y}_{o} \\ {z}_{o}\end{matrix} ) \qquad ( 9 )$$

As for uniformly reducing the first non-full-screen window by 50% into the second non-full-screen window, and moving the second non-full-screen window by Δx, Δy respectively in the horizontal direction and the vertical direction, a corresponding first transforming matrix is

$$( \begin{matrix}1 / 2 & 0 & Δ x \\ 0 & 1 / 2 & Δ y \\ 0 & 0 & 1 / 2\end{matrix} ) ,$$

and a three-dimension coordinates (xₜ, yₜ, zₜ) of a pixel point in the frame buffer data of the second non-full-screen window is shown in Equation (10):

$$( {x}_{t} , {y}_{t} , {z}_{t} ) = ( \begin{matrix}1 / 2 & 0 & Δ x \\ 0 & 1 / 2 & Δ y \\ 0 & 0 & 1 / 2\end{matrix} ) \times ( \begin{matrix}{x}_{o} \\ {y}_{o} \\ {z}_{o}\end{matrix} ) \qquad ( 10 )$$

As for uniformly reducing the first non-full-screen window by 50% into the second non-full-screen window, and clockwise rotating the second non-full-screen window by an angle θ, a corresponding first transforming matrix is

$$( \begin{matrix}cos θ / 2 & sin θ / 2 & 0 \\ - sin θ / 2 & cos θ / 2 & 0 \\ 0 & 0 & 1 / 2\end{matrix} ) ,$$

and a three-dimension coordinates (xₜ, yₜ, zₜ) of a pixel point in the frame buffer data of the second non-full-screen window is shown in Equation (11):

$$( {x}_{t} , {y}_{t} , {z}_{t} ) = ( \begin{matrix}cos θ / 2 & sin θ / 2 & 0 \\ - sin θ / 2 & cos θ / 2 & 0 \\ 0 & 0 & 1 / 2\end{matrix} ) \times ( \begin{matrix}{x}_{o} \\ {y}_{o} \\ {z}_{o}\end{matrix} ) \qquad ( 11 )$$

In practice, it is possible for non-uniformly transforming the first non-full-screen window into the second non-full-screen window. The first transforming matrix corresponding to the non-uniformly transforming may be determined according to the aspect ratio of the second non-full-screen window, and the description thereof will be omitted.

In practice, in the case where the first non-full-screen window is transformed into the second non-full-screen window for the first time, the initial position of the second non-full-screen window in the touch display unit may be preset, information about a area in the touch display unit of the electronic apparatus assigned by a user may be acquired by an interacting operation and the assigned area may be taken as the second display area of the second non-full-screen window. After the second non-full-screen window is displayed and an operation of scaling, moving or rotating the second non-full-screen window is received, then the operation is parsed to acquire a corresponding parameter for performing scaling, moving or rotating, the first transforming matrix is determined and Step 1002 is performed.

Step 1003, displaying the second non-full-screen window for replacing the first non-full-screen window for the first application by using the frame buffer data, so as to display the first application in a corresponding second non-full-screen window.

In the case where the first non-full-screen window is displayed on the touch display unit by the electronic apparatus for the first time, the first non-full-screen window is displayed in a same manner as the second non-full-screen window and the description thereof will be omitted.

According to the embodiment, in the case of the first application being displayed in the first non-full-screen window, the first operation of an electronic apparatus user may be received by the virtual function key, and different transforming operations may be performed on the first non-full-screen window in response to the first operation in the case where the first parsing result corresponding to the first operation meets the first condition or the second condition. The transforming operation may include an operation such as full-screen displaying, scaling or moving. Therefore, different transforming operations may be performed on the first non-full-screen window by the user of the electronic apparatus through only the virtual function key, the operating time is significantly saved and the user's experience is improved.

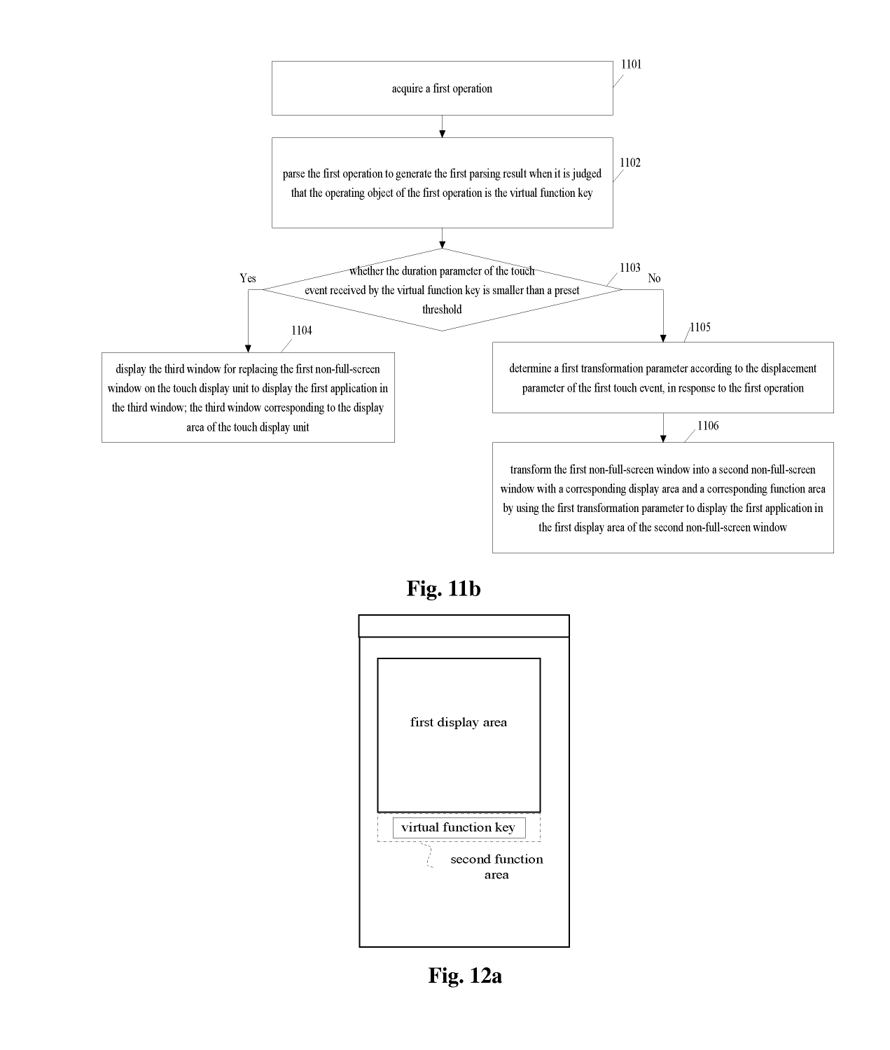

An embodiment of the disclosure provides a method for information processing for an electronic apparatus with a touch display unit. In the case where a first application is run on the electronic apparatus, a first non-full-screen window with a first display area and a second function area is displayed on the touch display unit. As shown in FIG. 1a, the first display area is configured to display the first application, the second function area includes a virtual function key and the first non-full-screen window is smaller than a display area of the touch display unit. FIG. 11b is a flowchart for a method for information processing according to the embodiment of the disclosure. As shown in FIG. 11b, the method for information processing includes the following steps 1101 to 1106.

Step 1101, acquiring a first operation.

Step 1102, parsing the first operation to generate a first parsing result in the case where it is judged that the operating object of the first operation is the virtual function key.

The first parsing result may include a duration parameter and a displacement parameter of the first touch event, and the first touch event is a touch event corresponding to the virtual function key which is triggered by the first operation. The duration parameter indicates the duration of the first touch event, and the displacement parameter indicates the displacement of a contact sensed by the touch display unit in an area corresponding to the virtual function key.

Step 1103, judging whether the duration parameter of the touch event received by the virtual function key is smaller than a preset threshold; performing Step 1104 in the case where the duration parameter is smaller than the preset threshold; and performing Step 1105 and Step 1106 successively in the case where the duration parameter is not smaller than the preset threshold.

Step 1104, displaying a third window for replacing the first non-full-screen window on the touch display unit to display the first application in the third window; the third window corresponds to the display area of the touch display unit. The third window may be obtained by transforming the first non-full-screen window by using a transformation parameter.

Since the third window corresponds to the display area of the touch display unit, then in Step 1103 and Step 1104, a state of displaying the first application in the non-full-screen first non-full-screen window may be switched into a state of displaying the first application in the full-screen third window, and the full-screen displaying of a non-full-screen window may be achieved through performing a singe-point or multi-point touch operation, of which the duration is not greater than the preset threshold, on the virtual function key via the electronic apparatus, the operation is simplified and the user's experience is improved.

Step 1105, determining a corresponding first transformation parameter, according to the displacement parameter of the first touch event, in response to the first operation.

Step 1106, transforming the first non-full-screen window into a second non-full-screen window with a corresponding first display area and a corresponding second function area by using the first transformation parameter, to display the first application in the first display area of the second non-full-screen window.

The second non-full-screen window is bigger or smaller than the first non-full-screen window, and is different from the third window.

By Step 1106, scaling the first non-full-screen window may be achieved, and switching a state of displaying the first application in the non-full-screen first non-full-screen window into a state of displaying the first application in the full-screen third window, and scaling the non-full-screen first non-full-screen window into the second non-full-screen window for displaying the first application both may be achieved by performing the first operation on the virtual function key, the operation is the simple and convenient.

According to a optional embodiment, transforming the first non-full-screen window, determining a second non-full-screen window with a corresponding first display area and a corresponding second function area by using the first transformation parameter, may include:

reading graphic buffer data of the first application;

converting the read graphic buffer data into graphic buffer data of the second non-full-screen window, and combining the graphic buffer data of the second non-full-screen window into frame buffer data of touch display unit; and

displaying the second non-full-screen window for replacing the first non-full-screen window on the touch display unit by using the frame buffer data to display the first application in the second non-full-screen window.

The first transformation parameter may at least include a parameter value, a matrix, a parameter group or a parameter set. In the case where the first transformation parameter is a matrix, displaying the first application on the first display area of the second non-full-screen window, i.e., switching a state of displaying the first application on the first display area of the first non-full-screen window into a state of displaying the first application on the first display area of the second non-full-screen window, will be described. As shown in FIG. 10a, the switching may include the following steps 1001 to 1003.

Step 1001, reading graphic buffer data of the first application.

The graphic buffer data of the first application which is plotted by the first application itself and used for full-screen displaying is written into a graphic buffer by the first application, i.e., the data is stored as graphic buffer data. The graphic buffer data may include two-dimension coordinates and Red, Green and Blue (RGB) information of a pixel point.

Step 1002, converting the read graphic buffer data of the first application into graphic buffer data of the second non-full-screen window by using the first transforming matrix, and combining the graphic buffer data of the second non-full-screen window into the frame buffer data of the touch display unit.

In the case where transforming first non-full-screen windows corresponding to more than one first applications into second non-full-screen windows, taking a first application 1 and a second application 2 as an example, the case that there may be an overlapping region between the second non-full-screen window of the application 1 and the second non-full-screen window of the application 2 is taken into consideration. As shown in FIG. 10b, there is an overlapping region between the second non-full-screen window 1 and the second non-full-screen window 2. Correspondingly, according to the embodiment, a two-dimension coordinates (x₀, y₀) indicating a pixel point in the graphic buffer data of first non-full-screen windows of the first application 1 and the first application 2, is extended into a three-dimension coordinates (x₀, y₀, z₀). The different non-full-screen windows have different third-dimension coordinates z₀. Therefore, the second non-full-screen window of the first application 1 and the second non-full-screen window of the first application 2 may be distinguished from each other by different third-dimension coordinates z₀ so as to determine the overlaying relationship of the overlapping area between the second non-full-screen window of the first application 1 and the second non-full-screen window of the first application 2. For example, in the case where there is an overlapping region between the second non-full-screen window 1 of the first application 1 and the second non-full-screen window 2 of the first application 2, the overlapping area between the second non-full-screen window 1 and the second non-full-screen window 2 is provided for displaying the first application 2 if the distance between the origin and the third-dimension coordinate of the second non-full-screen window 2 is greater than the distance between the origin and the third-dimension coordinate of second non-full-screen window 1 thus a part of the second non-full-screen window 1 is overlaid by the second non-full-screen window 2.

In related art, the graphic buffer data read in Step 1001 and graphic buffer data of the conventional first application (e.g., the status bar) in electronic apparatus may be combined into the frame buffer data as the content for full-screen displaying by the electronic apparatus. Therefore, according to the embodiment, the first non-full-screen window may be transformed into the second non-full-screen window though converting the extended three-dimension coordinates (x₀, y₀, z₀) in the graphic buffer data by using the first transforming matrix. The converted graphic buffer data may include the converted (x₀, y₀, z₀) and the RGB information of pixel points.

As for uniformly reducing the first non-full-screen window by 50% into the second non-full-screen window, a corresponding first transforming matrix is

$$( \begin{matrix}1 / 2 & 0 & 0 \\ 0 & 1 / 2 & 0 \\ 0 & 0 & 1 / 2\end{matrix} ) ,$$

and a three-dimension coordinates (xₜ, yₜ, zₜ) of a pixel point in the frame buffer data of the second non-full-screen window is shown in Equation (9):

$$( {x}_{t} , {y}_{t} , {z}_{t} ) = ( \begin{matrix}1 / 2 & 0 & 0 \\ 0 & 1 / 2 & 0 \\ 0 & 0 & 1 / 2\end{matrix} ) \times ( \begin{matrix}{x}_{o} \\ {y}_{o} \\ {z}_{o}\end{matrix} ) \qquad ( 9 )$$

As for uniformly reducing the first non-full-screen window by 50% into the second non-full-screen window, and moving the second non-full-screen window by Δx, Δy respectively in the horizontal direction and the vertical direction, a corresponding first transforming matrix is

$$( \begin{matrix}1 / 2 & 0 & Δ x \\ 0 & 1 / 2 & Δ y \\ 0 & 0 & 1 / 2\end{matrix} ) ,$$

and a three-dimension coordinates (xₜ, yₜ, zₜ) of a pixel point in the frame buffer data of the second non-full-screen window is shown in Equation (10):

$$( {x}_{t} , {y}_{t} , {z}_{t} ) = ( \begin{matrix}1 / 2 & 0 & Δ x \\ 0 & 1 / 2 & Δ y \\ 0 & 0 & 1 / 2\end{matrix} ) \times ( \begin{matrix}{x}_{o} \\ {y}_{o} \\ {z}_{o}\end{matrix} ) \qquad ( 10 )$$

As for uniformly reducing the first non-full-screen window by 50% into the second non-full-screen window, and clockwise rotating the second non-full-screen window by an angle θ, a corresponding first transforming matrix is

$$( \begin{matrix}cos θ / 2 & sin θ / 2 & 0 \\ - sin θ / 2 & cos θ / 2 & 0 \\ 0 & 0 & 1 / 2\end{matrix} ) ,$$

and a three-dimension coordinates (xₜ, yₜ, zₜ) of a pixel point in the frame buffer data of the second non-full-screen window is shown in Equation (11):

$$( {x}_{t} , {y}_{t} , {z}_{t} ) = ( \begin{matrix}cos θ / 2 & sin θ / 2 & 0 \\ - sin θ / 2 & cos θ / 2 & 0 \\ 0 & 0 & 1 / 2\end{matrix} ) \times ( \begin{matrix}{x}_{o} \\ {y}_{o} \\ {z}_{o}\end{matrix} ) \qquad ( 11 )$$

In practice, it is possible for non-uniformly transforming the first non-full-screen window into the second non-full-screen window. The first transforming matrix corresponding to the non-uniformly transforming may be determined according to the aspect ratio of the second non-full-screen window, and the description thereof will be omitted.

In practice, in the case where the first non-full-screen window is transformed into the second non-full-screen window for the first time, the initial position of the second non-full-screen window in the touch display unit may be preset, information about a area in the touch display unit of the electronic apparatus assigned by a user may be acquired by an interacting operation and the assigned area may be taken as the second display area of the second non-full-screen window. After the second non-full-screen window is displayed and an operation of scaling, moving or rotating the second non-full-screen window is received, then the operation is parsed to acquire a corresponding parameter for performing scaling, moving or rotating, the first transforming matrix is determined and Step 1002 is performed.

Step 1003, displaying the second non-full-screen window for replacing the first non-full-screen window for the first application by using the frame buffer data, so as to display the first application in a corresponding second non-full-screen window.

In the case where the first non-full-screen window is displayed on the touch display unit by the electronic apparatus for the first time, the first non-full-screen window is displayed in a same manner as the second non-full-screen window and the description thereof will be omitted.

According to the embodiment, in the case of the first application being displayed in the first non-full-screen window, the first operation of an electronic apparatus user may be received by the virtual function key, and different transforming operations may be performed on the first non-full-screen window in response to the first operation in the case where the first parsing result corresponding to the first operation meets the first condition or the second condition. The transforming operation may include an operation such as full-screen displaying, scaling or moving. Therefore, different transforming operations may be performed on the first non-full-screen window by the user of the electronic apparatus through only the virtual function key, the operating time is significantly saved and the user's experience is improved.

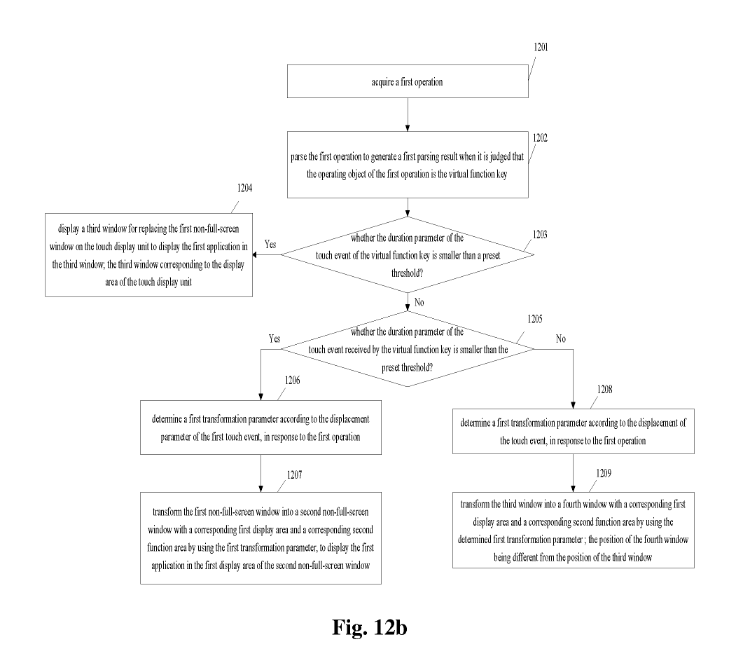

An embodiment of the disclosure provides a method for information processing for an electronic apparatus with a touch display unit. In the case where a first application is run on the electronic apparatus, a first non-full-screen window with a first display area and a second function area is displayed on the touch display unit. As shown in FIG. 12a, the first display area is configured to display the first application, the second function area includes a virtual function key and the first non-full-screen window is smaller than a display area of the touch display unit. FIG. 12b is a third flowchart for an information processing method according to the embodiment of the disclosure. As shown in FIG. 4b, the information processing method includes the following steps 1201 to 1209.

Step 1201, acquiring a first operation.

Step 1202, parsing the first operation to generate a first parsing result in the case where it is judged that the operating object of the first operation is the virtual function key.

The first parsing result may include a duration parameter of a first touch event, and the first touch event is a touch event corresponding to the virtual function key which is triggered by the first operation. The duration parameter indicates a duration of the first touch event, the displacement parameter indicates a displacement of a touch point sensed by the touch display unit in an area corresponding to the virtual function key, and the touch-point parameter indicates a number of touch points sensed by the touch display unit in an area corresponding to the virtual function key in the case where the first touch event is triggered by the first operation.

Step 1203, judging whether the duration parameter of the touch event received by the virtual function key is smaller than a preset threshold; performing Step 1204 in the case where the duration parameter is smaller than the preset threshold; and performing Step 1205 in the case where the duration parameter is not smaller than the preset threshold.

Step 1204, displaying a third window for replacing the first non-full-screen window on the touch display unit, to display the first application in the third window; the third window corresponding to the display area of the touch display unit.

Since the third window corresponds to the display area of the touch display unit, then in Step 1203 and Step 1204, a state of displaying the first application in the non-full-screen first non-full-screen window may be switched into a state of displaying the first application in the full-screen third window, and a non-full-screen window being switched to the full-screen displaying may be achieved through performing a singe-point or multi-point touch operation of which the duration is not greater than the preset threshold, on the virtual function key via the user of the electronic apparatus, the operation is simplified and the user's experience is improved.

Step 1205, judging whether the number of the touch points sensed by virtual function key, which is indicated by the touch-point parameter, meets a third condition; performing Step 1206 and Step 1207 successively in the case where the number of the touch points meets the third condition; and performing Step 1208 and Step 1209 successively in the case where the number of the touch points does not meet the third condition.

The third condition may include a value range of the number of the touch points which is indicated by the touch-point parameter. For example, in the case where the electronic apparatus is to be triggered by the first operation of applying single-point touch on the virtual function key to perform Step 1206 and Step 1207, the third condition is that the number of the touch points which is indicated by the touch-point parameter is one. Correspondingly, in the case where the first operation is a multi-point touch performed on the virtual function key, the electronic apparatus is triggered to perform Step 1208 and Step 1209.

Step 1206, determining a corresponding first transformation parameter according to the displacement parameter of the first touch event, in response to the first operation.

Step 1207, transforming the first non-full-screen window into a second non-full-screen window with a corresponding first display area and a corresponding second function area by using the first transformation parameter, to display the first application in the first display area of the second non-full-screen window; the second non-full-screen window being different from the first non-full-screen window.

Step 1208, determining a corresponding first transformation parameter according to the displacement parameter of the first touch event.

Step 1209, transforming the third window into a fourth non-full-screen window with a corresponding first display area and a corresponding second function area by using the determined first transformation parameter, to display the first application in the first display area of the fourth non-full-screen window; the position of the fourth non-full-screen window being different from the position of the third window.

According to a optional embodiment, transforming the first non-full-screen window into a second non-full-screen window with a corresponding first display area and a corresponding second function area by using the first transformation parameter, may include:

reading graphic buffer data of the first application;

converting the read graphic buffer data into graphic buffer data of the second non-full-screen window, and combining the graphic buffer data of the second non-full-screen window into frame buffer data of touch display unit; and

displaying the second non-full-screen window for replacing the first non-full-screen window on the touch display unit by using the frame buffer data, to display the first application on the first display area of the second non-full-screen window.

The first transformation parameter may at least include: a parameter value, a matrix, a parameter group or a parameter set. In the case where the first transformation parameter is a matrix, displaying the first application in the first display area of the second non-full-screen window (i.e., switching a state of displaying the first application on the first display area of the first non-full-screen window into a state of displaying the first application on the second non-full-screen window) will be described. As shown in FIG. 10a, the switching may include the following steps 1001 to 1003.

Step 1001, reading graphic buffer data of the first application.

The graphic buffer data of the first application which is plotted by the first application itself and used for full-screen displaying is written into a graphic buffer by the first application, i.e., the data is stored as graphic buffer data. The graphic buffer data may include two-dimension coordinates and Red, Green and Blue (RGB) information of a pixel point.

Step 1002, converting the read graphic buffer data of the first application into graphic buffer data of the second non-full-screen window by using the first transforming matrix, and combining the graphic buffer data of the second non-full-screen window into the frame buffer data of the touch display unit.

In the case where transforming first non-full-screen windows corresponding to more than one first applications into second non-full-screen windows, taking a first application 1 and a second application 2 as an example, the case that there may be an overlapping region between the second non-full-screen window of the application 1 and the second non-full-screen window of the application 2 is taken into consideration. As shown in FIG. 10b, there is an overlapping region between the second non-full-screen window 1 and the second non-full-screen window 2. Correspondingly, according to the embodiment, a two-dimension coordinates (x₀, y₀) indicating a pixel point in the graphic buffer data of first non-full-screen windows of the first application 1 and the first application 2, is extended into a three-dimension coordinates (x₀, y₀, z₀). The different non-full-screen windows have different third-dimension coordinates z₀. Therefore, the second non-full-screen window of the first application 1 and the second non-full-screen window of the first application 2 may be distinguished from each other by different third-dimension coordinates z₀ so as to determine the overlaying relationship of the overlapping area between the second non-full-screen window of the first application 1 and the second non-full-screen window of the first application 2. For example, in the case where there is an overlapping region between the second non-full-screen window 1 of the first application 1 and the second non-full-screen window 2 of the first application 2, the overlapping area between the second non-full-screen window 1 and the second non-full-screen window 2 is provided for displaying the first application 2 if the distance between the origin and the third-dimension coordinate of the second non-full-screen window 2 is greater than the distance between the origin and the third-dimension coordinate of second non-full-screen window 1 thus a part of the second non-full-screen window 1 is overlaid by the second non-full-screen window 2.

In related art, the graphic buffer data read in Step 1001 and graphic buffer data of the conventional first application (e.g., the status bar) in electronic apparatus may be combined into the frame buffer data as the content for full-screen displaying by the electronic apparatus. Therefore, according to the embodiment, the first non-full-screen window may be transformed into the second non-full-screen window though converting the extended three-dimension coordinates (x₀, y₀, z₀) in the graphic buffer data by using the first transforming matrix. The converted graphic buffer data may include the converted (x₀, y₀, z₀) and the RGB information of pixel points.

As for uniformly reducing the first non-full-screen window by 50% into the second non-full-screen window, a corresponding first transforming matrix is

$$( \begin{matrix}1 / 2 & 0 & 0 \\ 0 & 1 / 2 & 0 \\ 0 & 0 & 1 / 2\end{matrix} ) ,$$

and a three-dimension coordinates (xₜ, yₜ, zₜ) of a pixel point in the frame buffer data of the second non-full-screen window is shown in Equation (9):

$$( {x}_{t} , {y}_{t} , {z}_{t} ) = ( \begin{matrix}1 / 2 & 0 & 0 \\ 0 & 1 / 2 & 0 \\ 0 & 0 & 1 / 2\end{matrix} ) \times ( \begin{matrix}{x}_{o} \\ {y}_{o} \\ {z}_{o}\end{matrix} ) \qquad ( 9 )$$

As for uniformly reducing the first non-full-screen window by 50% into the second non-full-screen window, and moving the second non-full-screen window by Δx, Δy respectively in the horizontal direction and the vertical direction, a corresponding first transforming matrix is

$$( \begin{matrix}1 / 2 & 0 & Δ x \\ 0 & 1 / 2 & Δ y \\ 0 & 0 & 1 / 2\end{matrix} ) ,$$

and a three-dimension coordinates (xₜ, yₜ, zₜ) of a pixel point in the frame buffer data of the second non-full-screen window is shown in Equation (10):

$$( {x}_{t} , {y}_{t} , {z}_{t} ) = ( \begin{matrix}1 / 2 & 0 & Δ x \\ 0 & 1 / 2 & Δ y \\ 0 & 0 & 1 / 2\end{matrix} ) \times ( \begin{matrix}{x}_{o} \\ {y}_{o} \\ {z}_{o}\end{matrix} ) \qquad ( 10 )$$

As for uniformly reducing the first non-full-screen window by 50% into the second non-full-screen window, and clockwise rotating the second non-full-screen window by an angle θ, a corresponding first transforming matrix is

$$( \begin{matrix}cos θ / 2 & sin θ / 2 & 0 \\ - sin θ / 2 & cos θ / 2 & 0 \\ 0 & 0 & 1 / 2\end{matrix} ) ,$$

and a three-dimension coordinates (x, yₜ, zₜ) of a pixel point in the frame buffer data of the second non-full-screen window is shown in Equation (11):

$$( {x}_{t} , {y}_{t} , {z}_{t} ) = ( \begin{matrix}cos θ / 2 & sin θ / 2 & 0 \\ - sin θ / 2 & cos θ / 2 & 0 \\ 0 & 0 & 1 / 2\end{matrix} ) \times ( \begin{matrix}{x}_{o} \\ {y}_{o} \\ {z}_{o}\end{matrix} ) \qquad ( 11 )$$

In practice, it is possible for non-uniformly transforming the first non-full-screen window into the second non-full-screen window. The first transforming matrix corresponding to the non-uniformly transforming may be determined according to the aspect ratio of the second non-full-screen window, and the description thereof will be omitted.

In practice, in the case where the first non-full-screen window is transformed into the second non-full-screen window for the first time, the initial position of the second non-full-screen window in the touch display unit may be preset, information about a area in the touch display unit of the electronic apparatus assigned by a user may be acquired by an interacting operation and the assigned area may be taken as the second display area of the second non-full-screen window. After the second non-full-screen window is displayed and an operation of scaling, moving or rotating the second non-full-screen window is received, then the operation is parsed to acquire a corresponding parameter for performing scaling, moving or rotating, the first transforming matrix is determined and Step 1002 is performed.

Step 1003, displaying the second non-full-screen window for replacing the first non-full-screen window for the first application by using the frame buffer data, so as to display the first application in a corresponding second non-full-screen window.

In the case where the first non-full-screen window is displayed on the touch display unit by the electronic apparatus for the first time, the first non-full-screen window is displayed in a same manner as the second non-full-screen window and the description thereof will be omitted.

According to the embodiment, the full-screen displaying, scaling and moving may be achieved on the first non-full-screen window by conveniently performing the first operation in different forms on the virtual function key, the operating time is significantly saved.

It is to be noted, the description in the embodiment of the electronic apparatus is similar to the description about the above method, and the advantages thereof will be omitted. For technical details which are not disclosed in the embodiment of the electronic apparatus, please refer to the description of an embodiment of the method according to the disclosure.

The embodiment of the disclosure provides an electronic apparatus. The electronic apparatus includes a touch display unit and a first processing unit.

The first processing unit is configured to display a first non-full-screen window with a first display area and a second function area on the touch display unit in the case where a first application is run. The first display area is configured to display the first application. The second function area includes a virtual function key. The first non-full-screen window is smaller than a display area of the touch display unit.

The electronic apparatus may further include:

an acquiring unit, configured to acquire a first operation;

an parsing unit, configured to parse the first operation to generate a first parsing result in the case where it is judged that the operating object of the first operation is the virtual function key;

a second processing unit, configured to, in the case where the first parsing result meets the first condition, display the third window for replacing the first non-full-screen window on the touch display unit to display the first application in the third window in response to the first operation; the third window being different from the first non-full-screen window; and

a second determining unit, configured to, in the case where the first parsing result meets a second condition, acquire a first transformation parameter, and transform the first non-full-screen window into a second non-full-screen window by using the first transformation parameter to display the first application in the second non-full-screen window in response to the first operation; the second non-full-screen window being different from either of the first non-full-screen window or the third window.

The first transformation parameter acquired by the second determining unit may at least include: a parameter value, a matrix, a parameter group or a parameter set.

In practice, the touch display unit may be implemented by a touch screen and a related circuit in the electronic apparatus. Each of the first processing unit, the acquiring unit, the parsing unit, the second processing unit and the second determining unit may be implemented by a CPU, DSP (Digital Signal Processor) or FPGA (Field Programmable Gate Array) in the electronic apparatus.

An embodiment of the disclosure provides an electronic apparatus. The electronic apparatus includes a touch display unit and a first processing unit.

The first processing unit is configured to display a first non-full-screen window with a display area and a second function area on the touch display unit in the case where a first application is run. The first display area is configured to display the first application. The second function area includes a virtual function key. The first non-full-screen window is smaller than a display area of the touch display unit.

The electronic apparatus may further include:

an acquiring unit, configured to acquire a first operation;

an parsing unit, configured to parse the first operation to generate a first parsing result in the case where it is judged that the operating object of the first operation is the virtual function key;

the parsing unit 64, further configured to judge whether the first parsing result meets a first condition or a second condition;

a second processing unit, configured to, in the case where the first parsing result meets the first condition, display a third window for replacing the first non-full-screen window on the touch display unit to display the first application in the third window in response to the first operation; the third window being different from the first non-full-screen window; and

a second determining unit, configured to, in the case where the first parsing result meets the second condition, acquire a first transformation parameter, and transform the first non-full-screen window into a second non-full-screen window by using the first transformation parameter to display the first application in the second non-full-screen window in response to the first operation; the second non-full-screen window being different from either of the first non-full-screen window or the third window.

The first parsing result may include a duration parameter of a first touch event corresponding to the virtual function key which is triggered by the first operation;

the second processing unit is further configured to, in the case where the duration parameter of the touch event received by the virtual function key is smaller than a preset threshold, display the third window for replacing the first non-full-screen window on the touch display unit 61 to display the first application in the third window; the third window corresponding to the display area of the touch display unit.

The first parsing result further may include a displacement parameter of the first touch event;

The second determining unit is further configured to, in the case where the duration parameter of the first touch event is equal to or greater than the preset threshold, determine a corresponding first transformation parameter according to the displacement parameter of the first touch event; and

transform the first non-full-screen window into a second non-full-screen window with a corresponding first display area and a corresponding second function area by using the determined first transformation parameter to display the first application in the first display area of the second non-full-screen window; the second non-full-screen window being bigger or smaller than the first non-full-screen window and being different from the third window.

The first parsing result further includes a touch-point parameter of the first touch event.

The electronic apparatus further includes: a judging unit and a fourth processing unit.

The judging unit is configured to judge whether the number of touch points sensed by the virtual function key, which is indicated by the touch-point parameter, meets a third condition; trigger the second determining unit in the case where the number of the touch points meets the third condition; and trigger the fourth processing unit in the case where the number of the touch points does not meet the third condition.

The fourth processing unit is configured to determine a corresponding first transformation parameter according to the displacement parameter of the first touch event;

and transform the third window into a fourth non-full-screen window with a corresponding first display area and a corresponding second function area by using the determined first transformation parameter, to display the first application in the first display area of the fourth non-full-screen window; the position of the fourth non-full-screen window being different from the position of the third window.

The second determining unit is further configured to read graphic buffer data of the first application;

convert the read graphic buffer data into graphic buffer data of the second non-full-screen window by using the transformation parameter, and combine the graphic buffer data of the second non-full-screen window into frame buffer data of the touch display unit 61; and

display the second non-full-screen window for replacing the first non-full-screen window on the touch display unit 61 by using the frame buffer data, to display the first application in the first display area of the second non-full-screen window.

The first transformation parameter acquired by the second determining unit may at least include: a parameter value, a matrix, a parameter group or a parameter set.

In practice, the touch display unit may be implemented by a touch screen and a related circuit in the electronic apparatus. Each of the first processing unit, the acquiring unit, the parsing unit, the second processing unit and the second determining unit 66 may be implemented by a CPU, DSP or FPGA in the electronic apparatus.

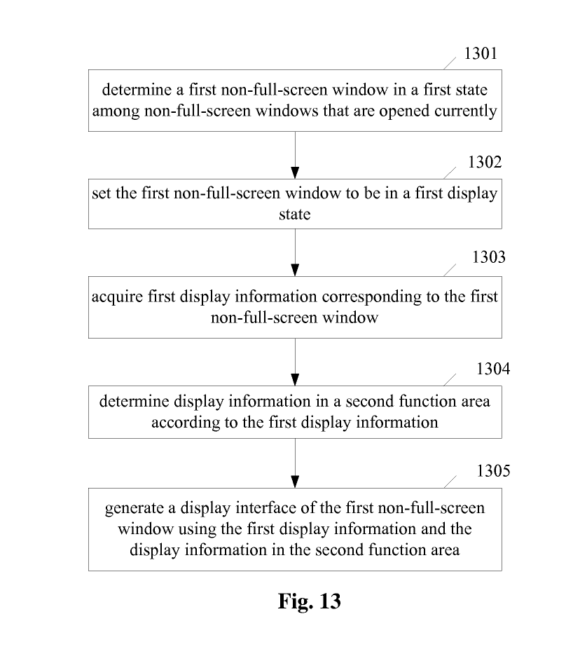

An embodiment of the disclosure provides a method for information processing applied in an electronic apparatus with a touch display unit, wherein a plurality of applications are able to be run on the electronic apparatus, and are displayed in a display area of the touch display unit, a full-screen display window corresponding to an application is transformed by the electronic apparatus by using a second transformation parameter, to obtain a non-full-screen window of the application; and in the case where the application is run in a non-full-screen mode in the electronic apparatus, and the non-full-screen window in which the application is run in the non-full-screen mode is opened, as show in FIG. 13, the method includes the following steps 1301 to 1305.

Step 1301 is to determine a first non-full-screen window in a first state among non-full-screen windows that are opened currently.

Step 1302 is to set the first non-full-screen window to a first display state.

Step 1303 is to acquire first display information corresponding to the first non-full-screen window.

Step 1304 is to determine display information in a second function area according to the first display information.

Step 1305 is to generate a display interface of the first non-full-screen window by using the first display information and the display information in the second function area.

The first non-full-screen window in the first state is a non-full-screen window, in which an interaction event takes place for the last time, among the N windows in which applications are run in the non-full-screen mode.

The first display state is a state of the second function area displayed in the first non-full-screen window.

The first display information may include a display position of the first display area in the first non-full-screen window, and graphic buffer data corresponding to the first non-full-screen window.

The determining display information in a second function area according to the first display information includes: extracting a display position of the first display area of the first non-full-screen window from the first display information; determining a display coordinate of the second function area according to the display position of the first display area, and determining graphic buffer data of the second function area; and combining the display coordinate of the second function area and the graphic buffer data into the display information in the second function area.

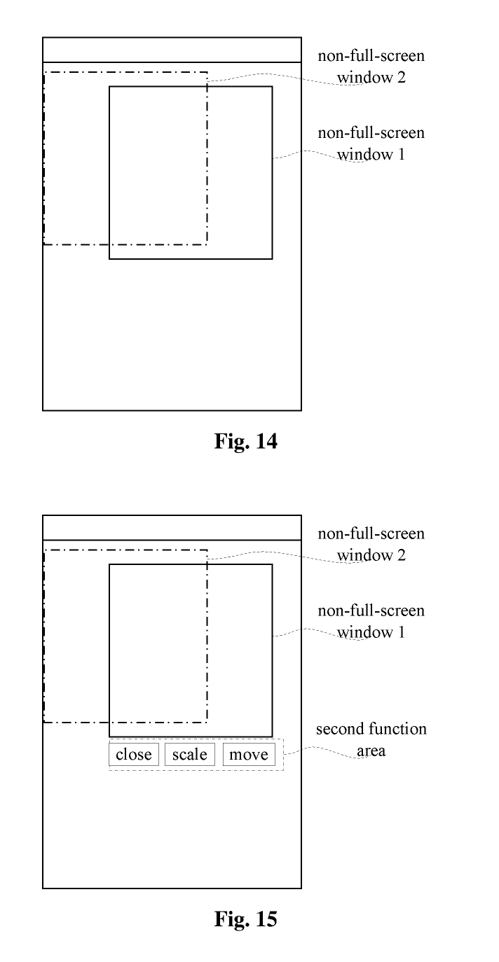

As shown in FIG. 14, the second function area is a region containing a virtual function key for controlling states of the first non-full-screen window, such as closing, scaling or moving.

To open a non-full-screen window in which the application is run in a non-full-screen window mode is: to select a application which is run in a non-full-screen window mode, to acquire a second transformation parameter; and to perform transformation on a full-screen display window corresponding to the application by using the second transformation parameter, to obtain the first display area of the non-full-screen window of the application.

To perform transformation on a display screen corresponding to the selected application by using the second transformation parameter to obtain the first display area of the non-full-screen window of the application is: to read the graphic buffer data of the application; to perform transformation on the read graphic buffer data by using the second transformation parameter, to generate frame buffer data corresponding to the touch display unit by using graphic buffer data transformed; and to display the non-full-screen window of the application in the touch display unit using the frame buffer data.

The second transformation parameter at least includes: parameter value, matrix, parameter group or parameter set.

The graphic buffer data may include: coordinate information of respective pixel points, and RGB (i.e., Red, Green and Blue) three-color information of respective pixel points.

Considering that an overlapped region may exists between the non-full-screen display windows corresponding to two applications, the coordinate information of the pixel point in the graphic buffer data of the non-full-screen display window corresponding to the application is set as a three-dimensional coordinate (xₒ, yₒ, zₒ). Different non-full-screen display windows have different third-dimensional coordinates zₒ, then in the case where two non-full-screen windows are overlapped, or are completely covered, different non-full-screen windows may be distinguished by using the third-dimensional coordinate.

The second transformation parameter may be a unit matrix. By performing transformation on the three-dimensional coordinate (xₒ, yₒ, zₒ) of the pixel point in the graphic buffer data expanded by using the second transformation parameter, the non-full-screen display window corresponding to the application can be obtained. The graphic buffer data corresponding to the non-full-screen display window include the transformed (xₒ, yₒ, zₒ) and the RGB information of the respective pixel points.

In this way, the application displayed in a full-screen mode can be transformed into the application displayed in a non-full-screen mode by using the transformation matrix, non-full-screen windows corresponding to a plurality of applications may be provided to the user, so that the content of the application that is run in any non-full-screen window can be looked up flexibly.

Optionally, a plurality of adjustments may be performed on the non-full-screen window. The adjustment is to adjust the transformation matrix corresponding to the non-full-screen window.

For example, in the case where the non-full-screen window is reduced by 50%, the transformation matrix corresponding to the non-full-screen window is

$$( \begin{matrix}1 / 2 & 0 & 0 \\ 0 & 1 / 2 & 0 \\ 0 & 0 & 1 / 2\end{matrix} )$$

according to the response information, and the three-dimensional coordinate (xₜ, yₜ, zₜ) of respective pixel in the frame buffer data corresponding to the non-full-screen window is:

$$( {x}_{t} , {y}_{t} , {z}_{t} ) = ( \begin{matrix}1 / 2 & 0 & 0 \\ 0 & 1 / 2 & 0 \\ 0 & 0 & 1 / 2\end{matrix} ) \times ( \begin{matrix}{x}_{o} \\ {y}_{o} \\ {z}_{o}\end{matrix} ) .$$

And the non-full-screen window is moved laterally by Δx, and longitudinally by Δy, then the transformation matrix of the non-full-screen window is

$$( \begin{matrix}1 / 2 & 0 & Δ x \\ 0 & 1 / 2 & Δ y \\ 0 & 0 & 1 / 2\end{matrix} ) ,$$

and the three-dimensional coordinate (xₜ, yₜ, zₜ) of respective pixel in the frame buffer data corresponding to the non-full-screen window is:

$$( {x}_{t} , {y}_{t} , {z}_{t} ) = ( \begin{matrix}1 / 2 & 0 & Δ x \\ 0 & 1 / 2 & Δ y \\ 0 & 0 & 1 / 2\end{matrix} ) \times ( \begin{matrix}{x}_{o} \\ {y}_{o} \\ {z}_{o}\end{matrix} ) .$$

The effect of this embodiment is shown in FIG. 14 and FIG. 15. For example, as shown in FIG. 14, two non-full-screen windows are opened currently, with the non-full-screen window 1 being in a first state, i.e., the window in which the user interaction has just been completed, and the non-full-screen window 2 being in a second state. In the case where it is determined that the first non-full-screen window is set to a second display state, i.e., it is determined that a control bar is added at the first non-full-screen window, the position of the control bar is determined according to the position of the first non-full-screen window, for example, at the lower ledge of the first non-full-screen window, and then the final display effect is shown in FIG. 15. Three operation keys for scaling, closing and moving are included in the control bar.

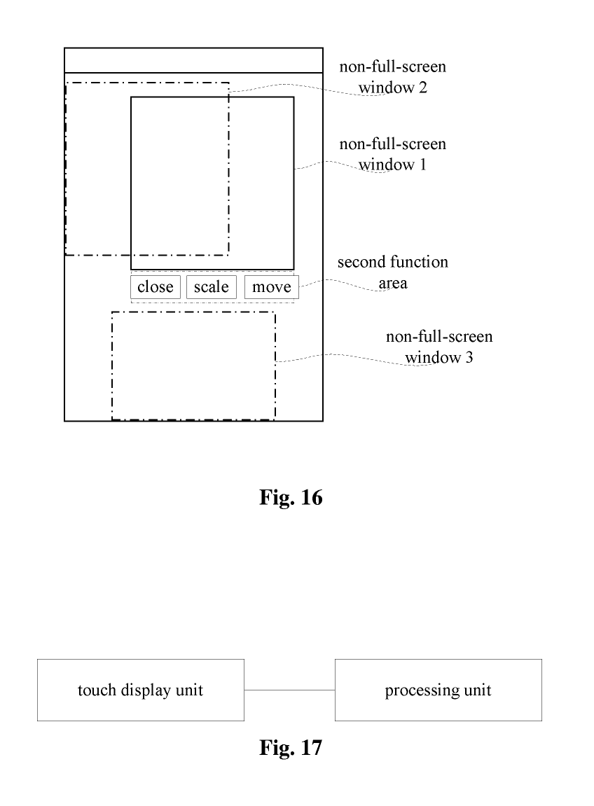

It is assumed that three non-full-screen windows are opened currently, as shown in FIG. 16, the non-full-screen window 1 is in a first state, i.e., the window in which the interaction event takes place for the last time, then the non-full-screen window 2 and the non-full-screen window 3 are in a second state, no control bar is displayed, and the control bar is displayed only below the non-full-screen window 1.

As can be seen, with the technical solution provided in the embodiment of the disclosure, the second function area can be displayed only in the non-full-screen window which is in the first state currently, so that the amount of display second function areas on the electronic apparatus is reduced, the mis-operations of the user are decreased, thus the use experience of the user is improved and the usability of a system with a plurality of small windows is ensured.

An embodiment of the disclosure provides a method for information processing applied in an electronic apparatus with a touch display unit, wherein a plurality of applications are able to be run on the electronic apparatus, and are displayed in a display area of the touch display unit, a full-screen display window corresponding to an application is transformed by the electronic apparatus by using a second transformation parameter, to obtain a non-full-screen window of the application; and in the case where the application is run in a non-full-screen mode in the electronic apparatus, and the non-full-screen window in which the application is run in the non-full-screen mode is opened, as show in FIG. 13, the method includes the following steps 1301 to 1305.

Step 1301 is to determine a first non-full-screen window in a first state among non-full-screen windows that are opened currently.

Step 1302 is to set the first non-full-screen window to a first display state.

Step 1303 is to acquire first display information corresponding to the first non-full-screen window.

Step 1304 is to determine display information in a second function area according to the first display information.

Step 1305 is to generate a display interface of the first non-full-screen window by using the first display information and the display information in the second function area.

The first non-full-screen window in the first state is a non-full-screen window, in which an interaction event takes place for the last time, among the N windows in which applications are run in the non-full-screen mode.

After step 1302, the method further includes: switching a non-full-screen window in a second state into a non-full-screen window in a second display state.

The non-full-screen window in the second state is the non-full-screen window that is not in the first state, and the second display state is the state in which the second function area is not displayed in the non-full-screen window.

The first display information may include a display position of the first display area in the first non-full-screen window, and graphic buffer data corresponding to the first non-full-screen window.

The determining display information in a second function area according to the first display information includes:

extracting a display position of the first display area of the first non-full-screen window from the first display information; determining a display coordinate of the second function area according to the display position of the first display area, and determining graphic buffer data of the second function area; and combining the display coordinate of the second function area and the graphic buffer data into the display information in the second function area.

As shown in FIG. 14, the second function area is a region containing a virtual function key for controlling states of the first non-full-screen window, such as closing, scaling or moving.

To open a non-full-screen window in which the application is run in a non-full-screen window mode is: to select a application which is run in a non-full-screen window mode, to acquire a second transformation parameter; and to perform transformation on a full-screen display window corresponding to the application by using the second transformation parameter, to obtain the first display area of the non-full-screen window of the application.

To perform transformation on a display screen corresponding to the selected application by using the second transformation parameter to obtain the first display area of the non-full-screen window of the application is: to read the graphic buffer data of the application; to perform transformation on the read graphic buffer data by using the second transformation parameter, to generate frame buffer data corresponding to the touch display unit by using graphic buffer data transformed; and to display the non-full-screen window of the application in the touch display unit using the frame buffer data.

The graphic buffer data may include: coordinate information of respective pixel points, and RGB (i.e., Red, Green and Blue) three-color information of respective pixel points.

Considering that an overlapped region may exists between the non-full-screen display windows corresponding to two applications, the coordinate information of the pixel point in the graphic buffer data of the non-full-screen display window corresponding to the application is set as a three-dimensional coordinate (xₒ, yₒ, zₒ). Different non-full-screen display windows have different third-dimensional coordinates zₒ, then in the case where two non-full-screen windows are overlapped, or are completely covered, different non-full-screen windows may be distinguished by using the third-dimensional coordinate.

The second transformation parameter at least includes: parameter value, matrix, parameter group or parameter set.

It is assumed that the second transformation parameter is a unit matrix. By performing transformation on the three-dimensional coordinate (xₒ, yₒ, zₒ) of the pixel point in the graphic buffer data expanded by using the second transformation parameter, the non-full-screen display window corresponding to the application can be obtained. The graphic buffer data corresponding to the non-full-screen display window include the transformed (xₒ, yₒ, zₒ) and the RGB information of the respective pixel points.

In this way, the application displayed in a full-screen mode can be transformed into the application displayed in a non-full-screen mode by using the transformation matrix, non-full-screen windows corresponding to a plurality of applications may be provided to the user, so that the content of the application that is run in any non-full-screen window can be looked up flexibly.

Optionally, a plurality of adjustments may be performed on the non-full-screen window. The adjustment is to adjust the transformation matrix corresponding to the non-full-screen window.

For example, in the case where the non-full-screen window is reduced by 50%, the transformation matrix corresponding to the non-full-screen window is

$$( \begin{matrix}1 / 2 & 0 & 0 \\ 0 & 1 / 2 & 0 \\ 0 & 0 & 1 / 2\end{matrix} )$$

according to the response information, and the three-dimensional coordinate (xₜ, yₜ, zₜ) of respective pixel in the frame buffer data corresponding to the non-full-screen window is:

$$( {x}_{t} , {y}_{t} , {z}_{t} ) = ( \begin{matrix}1 / 2 & 0 & 0 \\ 0 & 1 / 2 & 0 \\ 0 & 0 & 1 / 2\end{matrix} ) \times ( \begin{matrix}{x}_{o} \\ {y}_{o} \\ {z}_{o}\end{matrix} ) .$$

And the non-full-screen window is moved laterally by Δx, and longitudinally by Δy, then the transformation matrix of the non-full-screen window is

$$( \begin{matrix}1 / 2 & 0 & Δ x \\ 0 & 1 / 2 & Δ y \\ 0 & 0 & 1 / 2\end{matrix} ) ,$$

and the three-dimensional coordinate (xₜ, yₜ, zₜ) of respective pixel in the frame buffer data corresponding to the non-full-screen window is:

$$( {x}_{t} , {y}_{t} , {z}_{t} ) = ( \begin{matrix}1 / 2 & 0 & Δ x \\ 0 & 1 / 2 & Δ y \\ 0 & 0 & 1 / 2\end{matrix} ) \times ( \begin{matrix}{x}_{o} \\ {y}_{o} \\ {z}_{o}\end{matrix} ) .$$

Optionally, after step 1305, the method may further include: detecting whether there is a second function area displayed another non-full-screen window except the first non-full-screen window, deleting second function area displayed in the another non-full-screen window if there is; the method returns to step 1301 if there is not.

The generating frame buffer data using the first display information and the display information in the second function area, and displaying the frame buffer data in the display area of the touch display unit includes:

generating frame buffer data of the display module according to the first display information in the first non-full-screen window and the display information in the second function area; and

displaying the frame buffer data in the display area of the touch display unit.

In the case where there exists another non-full-screen window in the first state, the another non-full-screen window will serve as the first non-full-screen window, and the second function area is transferred into the new first non-full-screen window.

The effect of this embodiment is shown in FIG. 14 and FIG. 15. For example, as shown in FIG. 14, two non-full-screen windows are opened currently, with the non-full-screen window 1 being in a first state, i.e., the window in which the user interaction has just been completed, and the non-full-screen window 2 being in a second state. In the case where it is determined that the first non-full-screen window is set to a second display state, i.e., it is determined that a control bar is added at the first non-full-screen window, the position of the control bar is determined according to the position of the first non-full-screen window, for example, at the lower ledge of the first non-full-screen window, and then the final display effect is shown in FIG. 15. Three operation keys for scaling, closing and moving are included in the control bar.

It is assumed that three non-full-screen windows are opened currently, as shown in FIG. 16, the non-full-screen window 1 is in a first state, i.e., the window in which the interaction event takes place for the last time, then the non-full-screen window 2 and the non-full-screen window 3 are in a second state, no control bar is displayed, and the control bar is displayed only below the non-full-screen window 1.

As can be seen, with the technical solution provided in the embodiment of the disclosure, the second function area can be displayed only in the non-full-screen window which is in the first state currently, so that the amount of display second function areas on the electronic apparatus is reduced, the mis-operations of the user are decreased, thus the use experience of the user is improved and the usability of a system with a plurality of small windows is ensured.

An embodiment of the disclosure provides a method for information processing applied in an electronic apparatus with a touch display unit, wherein a plurality of applications are able to be run on the electronic apparatus, and are displayed in a display area of the touch display unit, a full-screen display window corresponding to an application is transformed by the electronic apparatus by using a second transformation parameter, to obtain a non-full-screen window of the application; and if N non-full-screen windows in which the application is run are opened, where N is an integer greater than or equal to 1, as show in FIG. 13, the method includes the following steps 1301 to 1305.

Step 1301 is to determine a first non-full-screen window in a first state among non-full-screen windows that are opened currently.

Step 1302 is to set the first non-full-screen window to a first display state.

Step 1303 is to acquire first display information corresponding to the first non-full-screen window.

Step 1304 is to determine display information in a second function area according to the first display information.

Step 1305 is to generate a display interface of the first non-full-screen window by using the first display information and the display information in the second function area.

The first non-full-screen window in the first state is a non-full-screen window, in which an interaction event takes place for the last time, among the N windows in which applications are run in the non-full-screen mode.

After step 1302, the method further includes: switching a non-full-screen window in a second state into a non-full-screen window in a second display state.

The non-full-screen window in the second state is the non-full-screen window that is not in the first state, and the second display state is the state in which the second function area is not displayed in the non-full-screen window, and is different from the first display state.

Optionally, to display the second function area in the non-full-screen window is: to display the second function area in a specified position of the non-full-screen window, such as below, right side of, left side of or above the non-full-screen window; and as shown in FIG. 15 and FIG. 16, the second function area, i.e. the state of the control bar, is displayed below the non-full-screen window 1.

The first display information may include a display position of the first display area in the first non-full-screen window, and graphic buffer data corresponding to the first non-full-screen window.

The first display information may include a display position of the first display area in the first non-full-screen window, and graphic buffer data corresponding to the first non-full-screen window.

The determining display information in a second function area according to the first display information includes:

extracting a display position of the first display area of the first non-full-screen window from the first display information; determining a display coordinate of the second function area according to the display position of the first display area, and determining graphic buffer data of the second function area; and combining the display coordinate of the second function area and the graphic buffer data into the display information in the second function area.

As shown in FIG. 14, the second function area is a region containing a virtual function key for controlling states of the first non-full-screen window, such as closing, scaling or moving.

To open a non-full-screen window in which the application is run in a non-full-screen window mode is: to select a application which is run in a non-full-screen window mode, to acquire a second transformation parameter; and to perform transformation on a full-screen display window corresponding to the application by using the second transformation parameter, to obtain the first display area of the non-full-screen window of the application.

To perform transformation on a display screen corresponding to the selected application by using the second transformation parameter to obtain the first display area of the non-full-screen window of the application is: to read the graphic buffer data of the application; to perform transformation on the read graphic buffer data by using the second transformation parameter, to generate frame buffer data corresponding to the touch display unit by using graphic buffer data transformed; and to display the non-full-screen window of the application in the touch display unit using the frame buffer data. The second transformation parameter at least includes: parameter value, matrix, parameter group or parameter set.

The graphic buffer data may include: coordinate information of respective pixel points, and RGB (i.e., Red, Green and Blue) three-color information of respective pixel points.

Considering that an overlapped region may exists between the non-full-screen display windows corresponding to two applications, the coordinate information of the pixel point in the graphic buffer data of the non-full-screen display window corresponding to the application is set as a three-dimensional coordinate (xₒ, yₒ, zₒ). Different non-full-screen display windows have different third-dimensional coordinates zₒ, then in the case where two non-full-screen windows are overlapped, or are completely covered, different non-full-screen windows may be distinguished by using the third-dimensional coordinate.

The second transformation parameter may be a unit matrix. By performing transformation on the three-dimensional coordinate (xₒ, yₒ, zₒ) of the pixel point in the graphic buffer data expanded by using the second transformation parameter, the non-full-screen display window corresponding to the application can be obtained. The graphic buffer data corresponding to the non-full-screen display window include the transformed (xₒ, yₒ, zₒ) and the RGB information of the respective pixel points.

In this way, the application displayed in a full-screen mode can be transformed into the application displayed in a non-full-screen mode by using the transformation matrix, non-full-screen windows corresponding to a plurality of applications may be provided to the user, so that the content of the application that is run in any non-full-screen window can be looked up flexibly.

Optionally, a plurality of adjustments may be performed on the non-full-screen window. The adjustment is to adjust the transformation matrix corresponding to the non-full-screen window.

For example, in the case where the non-full-screen window is reduced by 50%, the transformation matrix corresponding to the non-full-screen window is

$$( \begin{matrix}1 / 2 & 0 & 0 \\ 0 & 1 / 2 & 0 \\ 0 & 0 & 1 / 2\end{matrix} )$$

according to the response information, and the three-dimensional coordinate (xₜ, yₜ, zₜ) of respective pixel in the frame buffer data corresponding to the non-full-screen window is:

$$( {x}_{t} , {y}_{t} , {z}_{t} ) = ( \begin{matrix}1 / 2 & 0 & 0 \\ 0 & 1 / 2 & 0 \\ 0 & 0 & 1 / 2\end{matrix} ) \times ( \begin{matrix}{x}_{o} \\ {y}_{o} \\ {z}_{o}\end{matrix} ) .$$

And the non-full-screen window is moved laterally by Δx, and longitudinally by Δy, then the transformation matrix of the non-full-screen window is

$$( \begin{matrix}1 / 2 & 0 & Δ x \\ 0 & 1 / 2 & Δ y \\ 0 & 0 & 1 / 2\end{matrix} ) ,$$

and the three-dimensional coordinate (xₜ, yₜ, zₜ) of respective pixel in the frame buffer data corresponding to the non-full-screen window is:

$$( {x}_{t} , {y}_{t} , {z}_{t} ) = ( \begin{matrix}1 / 2 & 0 & Δ x \\ 0 & 1 / 2 & Δ y \\ 0 & 0 & 1 / 2\end{matrix} ) \times ( \begin{matrix}{x}_{o} \\ {y}_{o} \\ {z}_{o}\end{matrix} ) .$$

The generating frame buffer data using the first display information and the display information in the second function area, and displaying the frame buffer data in the display area of the touch display unit includes:

adding a display parameter of the second function area into the display information in the second function area; generating frame buffer data of the display module according to the first display information in the first non-full-screen window and the display information in the second function area; and displaying the frame buffer data in the display area of the touch display unit.

The display parameter of the second function area may include: display color, display transparency of the second function area and the like.

After step 1305, the method may further include: starting to time after the interaction event is completed in the first non-full-screen window; generating a judgment result when the length of the timing arrives at a preset count threshold; and changing the display parameter of the first non-full-screen window according to the adjustment result, thus the display effect of the first non-full-screen window is changed.

The display effect may be to hide completely the second function area in the first non-full-screen window, or to switch the functional function in the first non-full-screen window to a semi-transparent state.

The effect of this embodiment is shown in FIG. 14 and FIG. 15. For example, as shown in FIG. 14, two non-full-screen windows are opened currently, with the non-full-screen window 1 being in a first state, i.e., the window in which the user interaction has just been completed, and the non-full-screen window 2 being in a second state. In the case where it is determined that the first non-full-screen window is set to a second display state, i.e., it is determined that a control bar is added at the first non-full-screen window, the position of the control bar is determined according to the position of the first non-full-screen window, for example, at the lower ledge of the first non-full-screen window, and then the final display effect is shown in FIG. 15. Three operation keys for scaling, closing and moving are included in the control bar.

It is assumed that three non-full-screen windows are opened currently, as shown in FIG. 16, the non-full-screen window 1 is in a first state, i.e., the window in which the interaction event takes place for the last time, then the non-full-screen window 2 and the non-full-screen window 3 are in a second state, no control bar is displayed, and the control bar is displayed only below the non-full-screen window 1.

As can be seen, with the technical solution provided in the embodiment of the disclosure, the second function area can be displayed only in the non-full-screen window which is in the first state currently, so that the amount of display second function areas on the electronic apparatus is reduced, the mis-operations of the user are decreased, thus the use experience of the user is improved and the usability of a system with a plurality of small windows is ensured.

Further, since the display parameter of the second function area may be changed in the embodiment of the disclosure, thus a diversified operation interface may be provided, and the use experience may be improved.

It is provided an electronic apparatus in an embodiment of the disclosure, which may be a mobile terminal, such as an intelligent phone or tablet computer. As shown in FIG. 17, the electronic apparatus includes a touch display unit and a processing unit.

The touch display is configured to transform a full-screen display window corresponding to the application by using a second transformation parameter to obtain a non-full-screen window corresponding to the application; and select a first non-full-screen window in a first state from non-full-screen windows that are opened currently in the touch display unit if N windows in which the application is run in a non-full-screen mode are opened, where N is an integer greater than or equal to 1, and the non-full-screen window in the non-full-screen mode is opened.

The processing unit is configured to run and to display a plurality applications in a display area of the touch display unit, the first non-full-screen window in the first state determined among the non-full-screen windows that are opened currently; set the first non-full-screen window to a first display state; to acquire first display information corresponding to the first non-full-screen window; determine display information in a second function area according to the first display information; and generate a display interface of the first non-full-screen window by using the first display information and the display information in the second function area, and display the display interface of the first non-full-screen window in the display area of the touch display unit.

The processing unit is further configured to set, as the first non-full-screen window in the first state, the non-full-screen window, in which an interaction event takes place for the last time, among the N windows in which the application is run in the non-full-screen mode.

The first display information may include a display position of the first display area in the first non-full-screen window, and graphic buffer data corresponding to the first non-full-screen window.

The processing unit is further configured to: extract a display position of the display area of the first non-full-screen window from the first display information; determine a display coordinate of the second function area according to the display position of the display area, and determining graphic buffer data of the second function area; and combine the display coordinate of the second function area and the graphic buffer data into the display information in the second function area.

The second function area is as shown in FIG. 15, and it is assumed that the second function area is a region containing a virtual function key for controlling states of the first non-full-screen window, such as closing, scaling or moving.

The processing unit is further configured to select an application which is run in a non-full-screen window mode, to obtain a second transformation parameter; and perform transformation on a full-screen display window corresponding to the application by using the second transformation parameter, to obtain the first display area of the non-full-screen window of the application.

The processing unit is further configured to read the graphic buffer data of the application; perform transformation on the read graphic buffer data by using the second transformation parameter, generate frame buffer data corresponding to the touch display unit by using the transformed graphic buffer data; and display the non-full-screen window of the application in the touch display unit using the frame buffer data.

The graphic buffer data may include: coordinate information of respective pixel points, and RGB (i.e., Red, Green and Blue) three-color information of respective pixel points.

Considering that an overlapped region may exists between the non-full-screen display windows corresponding to two applications, the coordinate information of the pixel point in the graphic buffer data of the non-full-screen display window corresponding to the application is set as a three-dimensional coordinate (xₒ, yₒ, zₒ). Different non-full-screen display windows have different third-dimensional coordinates zₒ, then in the case where two non-full-screen windows are overlapped, or are completely covered, different non-full-screen windows may be distinguished by using the third-dimensional coordinate.

The second transformation parameter may be a unit matrix. By performing transformation on the three-dimensional coordinate (xₒ, yₒ, zₒ) of the pixel point in the graphic buffer data expanded by using the second transformation parameter, the non-full-screen display window corresponding to the application can be obtained. The graphic buffer data corresponding to the non-full-screen display window include the transformed (xₒ, yₒ, zₒ) and the RGB information of the respective pixel points. The second transformation parameter at least includes: parameter value, matrix, parameter group or parameter set.

In this way, the application displayed in a full-screen mode can be transformed into the application displayed in a non-full-screen mode by using the transformation matrix, non-full-screen windows corresponding to a plurality of applications may be provided to the user, so that the content of the application that is run in any non-full-screen window can be looked up flexibly.

Optionally, a plurality of adjustments may be performed on the non-full-screen window. The adjustment is to adjust the transformation matrix corresponding to the non-full-screen window.

For example, in the case where the non-full-screen window is reduced by 50%, the transformation matrix corresponding to the non-full-screen window is

$$( \begin{matrix}1 / 2 & 0 & 0 \\ 0 & 1 / 2 & 0 \\ 0 & 0 & 1 / 2\end{matrix} )$$

according to the response information, and the three-dimensional coordinate (xₜ, yₜ, zₜ) of respective pixel in the frame buffer data corresponding to the non-full-screen window is:

$$( {x}_{t} , {y}_{t} , {z}_{t} ) = ( \begin{matrix}1 / 2 & 0 & 0 \\ 0 & 1 / 2 & 0 \\ 0 & 0 & 1 / 2\end{matrix} ) \times ( \begin{matrix}{x}_{o} \\ {y}_{o} \\ {z}_{o}\end{matrix} ) .$$

And the non-full-screen window is moved laterally by Δx, and longitudinally by Δy, then the transformation matrix of the non-full-screen window is

$$( \begin{matrix}1 / 2 & 0 & Δ x \\ 0 & 1 / 2 & Δ y \\ 0 & 0 & 1 / 2\end{matrix} )$$

and the three-dimensional coordinate (xₜ, yₜ, zₜ) of respective pixel in the frame buffer data corresponding to the non-full-screen window is:

$$( {x}_{t} , {y}_{t} , {z}_{t} ) = ( \begin{matrix}1 / 2 & 0 & Δ x \\ 0 & 1 / 2 & Δ y \\ 0 & 0 & 1 / 2\end{matrix} ) \times ( \begin{matrix}{x}_{o} \\ {y}_{o} \\ {z}_{o}\end{matrix} ) .$$

The effect of this embodiment is shown in FIG. 14 and FIG. 15. For example, as shown in FIG. 14, two non-full-screen windows are opened currently, with the non-full-screen window 1 being in a first state, i.e., the window in which the user interaction has just been completed, and the non-full-screen window 2 being in a second state. In the case where it is determined that the first non-full-screen window is set to a second display state, i.e., it is determined that a control bar is added at the first non-full-screen window, the position of the control bar is determined according to the position of the first non-full-screen window, for example, at the lower ledge of the first non-full-screen window, and then the final display effect is shown in FIG. 15. Three operation keys for scaling, closing and moving are included in the control bar.

It is assumed that three non-full-screen windows are opened currently, as shown in FIG. 16, the non-full-screen window 1 is in a first state, i.e., the window in which the interaction event takes place for the last time, then the non-full-screen window 2 and the non-full-screen window 3 are in a second state, no control bar is displayed, and the control bar is displayed only below the non-full-screen window 1.

As can be seen, with the technical solution provided in the embodiment of the disclosure, the second function area can be displayed only in the non-full-screen window which is in the first state currently, so that the amount of display second function areas on the electronic apparatus is reduced, the mis-operations of the user are decreased, thus the use experience of the user is improved and the usability of a system with a plurality of small windows is ensured.

It is provided an electronic apparatus in an embodiment of the disclosure, which may be a mobile terminal, such as an intelligent phone or tablet computer. As shown in FIG. 17, the electronic apparatus includes a touch display unit and a processing unit.

The touch display is configured to transform a full-screen display window corresponding to the application by using a second transformation parameter to obtain a non-full-screen window corresponding to the application; and select a first non-full-screen window in a first state from non-full-screen windows that are opened currently in the touch display unit if N windows in which the application is run in a non-full-screen mode are opened, where N is an integer greater than or equal to 1, and the non-full-screen window in the non-full-screen mode is opened.

The processing unit is configured to run and to display a plurality applications in a display area of the touch display unit, the first non-full-screen window in the first state determined among the non-full-screen windows that are opened currently; set the first non-full-screen window to a first display state; to acquire first display information corresponding to the first non-full-screen window; determine display information in a second function area according to the first display information; and generate a display interface of the first non-full-screen window by using the first display information and the display information in the second function area, and display the display interface of the first non-full-screen window in the display area of the touch display unit.

The processing unit is further configured to set, as the first non-full-screen window in the first state, the non-full-screen window, in which an interaction event takes place for the last time, among the N windows in which the application is run in the non-full-screen mode.

The first display information may include a display position of the first display area in the first non-full-screen window, and graphic buffer data corresponding to the first non-full-screen window.

The processing unit is further configured to switch a non-full-screen window in a second state into a non-full-screen window in a second display state. The non-full-screen window in the second state is a non-full-screen window that is not in the first state, the second display state is different from the first display state, and the second display state is the state in which the second function area in the non-full-screen window is not displayed.

The processing unit is further configured to: extract a display position of the display area of the first non-full-screen window from the first display information; determine a display coordinate of the second function area according to the display position of the display area, and determining graphic buffer data of the second function area; and combine the display coordinate of the second function area and the graphic buffer data into the display information in the second function area.

The second function area is a region of a virtual function key for controlling states of the first non-full-screen window, such as closing, scaling or moving.

The processing unit is further configured to select an application which is run in a non-full-screen window mode, to obtain a second transformation parameter; and perform transformation on a full-screen display window corresponding to the application by using the second transformation parameter, to obtain the first display area of the non-full-screen window of the application. The second transformation parameter at least includes: parameter value, matrix, parameter group or parameter set.

The processing unit is further configured to read the graphic buffer data of the application; perform transformation on the read graphic buffer data by using the second transformation parameter, generate frame buffer data corresponding to the touch display unit by using the transformed graphic buffer data; and display the non-full-screen window of the application in the touch display unit using the frame buffer data.

The graphic buffer data may include: coordinate information of respective pixel points, and RGB (i.e., Red, Green and Blue) three-color information of respective pixel points.

Considering that an overlapped region may exists between the non-full-screen display windows corresponding to two applications, the coordinate information of the pixel point in the graphic buffer data of the non-full-screen display window corresponding to the application is set as a three-dimensional coordinate (xₒ, yₒ, zₒ). Different non-full-screen display windows have different third-dimensional coordinates zₒ, then in the case where two non-full-screen windows are overlapped, or are completely covered, different non-full-screen windows may be distinguished by using the third-dimensional coordinate.

The second transformation parameter may be a unit matrix. By performing transformation on the three-dimensional coordinate (xₒ, yₒ, zₒ) of the pixel point in the graphic buffer data expanded by using the second transformation parameter, the non-full-screen display window corresponding to the application can be obtained. The graphic buffer data corresponding to the non-full-screen display window include the transformed (xₒ, yₒ, zₒ) and the RGB information of the respective pixel points.

In this way, the application displayed in a full-screen mode can be transformed into the application displayed in a non-full-screen mode by using the transformation matrix, non-full-screen windows corresponding to a plurality of applications may be provided to the user, so that the content of the application that is run in any non-full-screen window can be looked up flexibly.

Optionally, a plurality of adjustments may be performed on the non-full-screen window. The adjustment is to adjust the transformation matrix corresponding to the non-full-screen window.

For example, in the case where the non-full-screen window is reduced by 50%, the transformation matrix corresponding to the non-full-screen window is

$$( \begin{matrix}1 / 2 & 0 & 0 \\ 0 & 1 / 2 & 0 \\ 0 & 0 & 1 / 2\end{matrix} )$$

according to the response information, and the three-dimensional coordinate (xₜ, yₜ, zₜ) of respective pixel in the frame buffer data corresponding to the non-full-screen window is:

$$( {x}_{t} , {y}_{t} , {z}_{t} ) = ( \begin{matrix}1 / 2 & 0 & 0 \\ 0 & 1 / 2 & 0 \\ 0 & 0 & 1 / 2\end{matrix} ) \times ( \begin{matrix}{x}_{o} \\ {y}_{o} \\ {z}_{o}\end{matrix} ) .$$

And the non-full-screen window is moved laterally by Δx, and longitudinally by Δy, then the transformation matrix of the non-full-screen window is

$$( \begin{matrix}1 / 2 & 0 & Δ x \\ 0 & 1 / 2 & Δ y \\ 0 & 0 & 1 / 2\end{matrix} ) ,$$

and the three-dimensional coordinate (xₜ, yₜ, zₜ) of respective pixel in the frame buffer data corresponding to the non-full-screen window is:

$$( {x}_{t} , {y}_{t} , {z}_{t} ) = ( \begin{matrix}1 / 2 & 0 & Δ x \\ 0 & 1 / 2 & Δ y \\ 0 & 0 & 1 / 2\end{matrix} ) \times ( \begin{matrix}{x}_{o} \\ {y}_{o} \\ {z}_{o}\end{matrix} ) .$$

The processing unit is further configured to generate frame buffer data of the display module according to the first display information in the first non-full-screen window and the display information in the second function area; and display the frame buffer data in the display area of the touch display unit.

The effect of this embodiment is shown in FIG. 14 and FIG. 15. For example, as shown in FIG. 14, two non-full-screen windows are opened currently, with the non-full-screen window 1 being in a first state, i.e., the window in which the user interaction has just been completed, and the non-full-screen window 2 being in a second state. In the case where it is determined that the first non-full-screen window is set to a second display state, i.e., it is determined that a control bar is added at the first non-full-screen window, the position of the control bar is determined according to the position of the first non-full-screen window, for example, at the lower ledge of the first non-full-screen window, and then the final display effect is shown in FIG. 15. Three operation keys for scaling, closing and moving are included in the control bar.

It is assumed that three non-full-screen windows are opened currently, as shown in FIG. 16, the non-full-screen window 1 is in a first state, i.e., the window in which the interaction event takes place for the last time, then the non-full-screen window 2 and the non-full-screen window 3 are in a second state, no control bar is displayed, and the control bar is displayed only below the non-full-screen window 1.

As can be seen, with the technical solution provided in the embodiment of the disclosure, the second function area can be displayed only in the non-full-screen window which is in the first state currently, so that the amount of display second function areas on the electronic apparatus is reduced, the mis-operations of the user are decreased, thus the use experience of the user is improved and the usability of a system with a plurality of small windows is ensured.

It is provided an electronic apparatus in an embodiment of the disclosure, which may be a mobile terminal, such as an intelligent phone or tablet computer. As shown in FIG. 17, the electronic apparatus includes a touch display unit and a processing unit.

The touch display is configured to transform a full-screen display window corresponding to the application by using a second transformation parameter to obtain a non-full-screen window corresponding to the application; and select a first non-full-screen window in a first state from non-full-screen windows that are opened currently in the touch display unit if N windows in which the application is run in a non-full-screen mode are opened, where N is an integer greater than or equal to 1, and the non-full-screen window in the non-full-screen mode is opened.

The processing unit is configured to run and to display a plurality applications in a display area of the touch display unit, the first non-full-screen window in the first state determined among the non-full-screen windows that are opened currently; set the first non-full-screen window to a first display state; to acquire first display information corresponding to the first non-full-screen window; determine display information in a second function area according to the first display information; and generate a display interface of the first non-full-screen window by using the first display information and the display information in the second function area, and display the display interface of the first non-full-screen window in the display area of the touch display unit.

The processing unit is further configured to set, as the first non-full-screen window in the first state, the non-full-screen window, in which an interaction event takes place for the last time, among the N windows in which the application is run in the non-full-screen mode.

The first display information may include a display position of the first display area in the first non-full-screen window, and graphic buffer data corresponding to the first non-full-screen window.

The processing unit is further configured to switch a non-full-screen window in a second state into a non-full-screen window in a second display state. The non-full-screen window in the second state is a non-full-screen window that is not in the first state, the second display state is different from the first display state, and the second display state is the state in which the second function area of the non-full-screen window is not displayed.

The processing unit is further configured to: extract a display position of the display area of the first non-full-screen window from the first display information; determine a display coordinate of the second function area according to the display position of the display area, and determining graphic buffer data of the second function area; and combine the display coordinate of the second function area and the graphic buffer data into the display information in the second function area.

The second function area is a region of a virtual function key for controlling states of the first non-full-screen window, such as closing, scaling or moving.

The processing unit is further configured to select an application which is run in a non-full-screen window mode, to obtain a second transformation parameter; and perform transformation on a full-screen display window corresponding to the application by using the second transformation parameter, to obtain the first display area of the non-full-screen window of the application.

The processing unit is further configured to read the graphic buffer data of the application; perform transformation on the read graphic buffer data by using the second transformation parameter, generate frame buffer data corresponding to the touch display unit by using the transformed graphic buffer data; and display the non-full-screen window of the application in the touch display unit using the frame buffer data.

The graphic buffer data may include: coordinate information of respective pixel points, and RGB (i.e., Red, Green and Blue) three-color information of respective pixel points.

Considering that an overlapped region may exists between the non-full-screen display windows corresponding to two applications, the coordinate information of the pixel point in the graphic buffer data of the non-full-screen display window corresponding to the application is set as a three-dimensional coordinate (xₒ, yₒ, zₒ). Different non-full-screen display windows have different third-dimensional coordinates zₒ, then in the case where two non-full-screen windows are overlapped, or are completely covered, different non-full-screen windows may be distinguished by using the third-dimensional coordinate.

The second transformation parameter may be a unit matrix. By performing transformation on the three-dimensional coordinate (xₒ, yₒ, zₒ) of the pixel point in the graphic buffer data expanded by using the second transformation parameter, the non-full-screen display window corresponding to the application can be obtained. The graphic buffer data corresponding to the non-full-screen display window include the transformed (xₒ, yₒ, zₒ) and the RGB information of the respective pixel points.

In this way, the application displayed in a full-screen mode can be transformed into the application displayed in a non-full-screen mode by using the transformation matrix, non-full-screen windows corresponding to a plurality of applications may be provided to the user, so that the content of the application that is run in any non-full-screen window can be looked up flexibly.

Optionally, a plurality of adjustments may be performed on the non-full-screen window. The adjustment is to adjust the transformation matrix corresponding to the non-full-screen window.

For example, in the case where the non-full-screen window is reduced by 50%, the transformation matrix corresponding to the non-full-screen window is

$$( \begin{matrix}1 / 2 & 0 & 0 \\ 0 & 1 / 2 & 0 \\ 0 & 0 & 1 / 2\end{matrix} )$$

according to the response information, and the three-dimensional coordinate (xₜ, yₜ, zₜ) of respective pixel in the frame buffer data corresponding to the non-full-screen window is:

$$( {x}_{t} , {y}_{t} , {z}_{t} ) = ( \begin{matrix}1 / 2 & 0 & 0 \\ 0 & 1 / 2 & 0 \\ 0 & 0 & 1 / 2\end{matrix} ) \times ( \begin{matrix}{x}_{o} \\ {y}_{o} \\ {z}_{o}\end{matrix} ) .$$

And the non-full-screen window is moved laterally by Δx, and longitudinally by Δy, then the transformation matrix of the non-full-screen window is

$$( \begin{matrix}1 / 2 & 0 & Δ x \\ 0 & 1 / 2 & Δ y \\ 0 & 0 & 1 / 2\end{matrix} ) ,$$

and the three-dimensional coordinate (xₜ, yₜ, zₜ) of respective pixel in the frame buffer data corresponding to the non-full-screen window is:

$$( {x}_{t} , {y}_{t} , {z}_{t} ) = ( \begin{matrix}1 / 2 & 0 & Δ x \\ 0 & 1 / 2 & Δ y \\ 0 & 0 & 1 / 2\end{matrix} ) \times ( \begin{matrix}{x}_{o} \\ {y}_{o} \\ {z}_{o}\end{matrix} ) .$$

The processing unit is further configured to add a display parameter of the second function area into the display information in the second function area; generate frame buffer data of the display module according to the first display information in the first non-full-screen window and the display information in the second function area; and display the frame buffer data in the display area of the touch display unit.

The display parameter of the second function area may include: display color, display transparency of the second function area and the like.

Preferably, the processing unit may be further configured to start to time after the interaction event is completed in the first non-full-screen window; generate a judgment result when the length of the timing arrives at a preset count threshold; and change the display parameter of the first non-full-screen window according to the adjustment result, thus the display effect of the first non-full-screen window is changed.

The effect of this embodiment is shown in FIG. 14 and FIG. 15. For example, as shown in FIG. 14, two non-full-screen windows are opened currently, with the non-full-screen window 1 being in a first state, i.e., the window in which the user interaction has just been completed, and the non-full-screen window 2 being in a second state. In the case where it is determined that the first non-full-screen window is set to a second display state, i.e., it is determined that a control bar is added at the first non-full-screen window, the position of the control bar is determined according to the position of the first non-full-screen window, for example, at the lower ledge of the first non-full-screen window, and then the final display effect is shown in FIG. 15. Three operation keys for scaling, closing and moving are included in the control bar.

It is assumed that three non-full-screen windows are opened currently, as shown in FIG. 16, the non-full-screen window 1 is in a first state, i.e., the window in which the interaction event takes place for the last time, then the non-full-screen window 2 and the non-full-screen window 3 are in a second state, no control bar is displayed, and the control bar is displayed only below the non-full-screen window 1.

As can be seen, with the technical solution provided in the embodiment of the disclosure, the second function area can be displayed only in the non-full-screen window which is in the first state currently, so that the amount of display second function areas on the electronic apparatus is reduced, the mis-operations of the user are decreased, thus the use experience of the user is improved and the usability of a system with a plurality of small windows is ensured.

Further, since the display parameter of the second function area may be changed in the embodiment of the disclosure, thus a diversified operation interface may be provided, and the use experience may be improved.

It should be understood that, in the several embodiments according to the disclosure, the disclosed apparatus and method may be implemented in other ways. The apparatus embodiments described above are merely illustrative. For example, the division for the units is only based on logic functions, and there may be other ways to divide in actual implementation. For example, multiple units or components may be combined or integrated into another system, or some features may be omitted or not be implemented. Moreover, the illustrated or discussed mutual coupling or direct coupling or communication connection among the components may be indirect coupling or communication connection via some interfaces, apparatuses or units, and may be electrical, mechanical or other forms.

The above units explained as separate members may be or may not be physically separated from each other. The members shown as units may be or may not be physical units, i.e., may be located in one position or may be distributed over multiple network units. The solution of the embodiment may be achieved by selecting a part or all of the units as desired.

Furthermore, the individual functional units of the embodiments of the disclosure may be integrated in a single processing unit, or each of the units may be a separate unit, or two or more of the units may integrated in a single unit. The integrated unit may be implemented in hardware, or in hardware and software functional units.

It should be understood by the skilled in the art should understand, a part or all of the steps of the above embodiments of the method may be performed via hardware related to the instructions of a program. The program may be stored in a computer readable storage medium, and when the program is executed, the steps of the embodiments of the method are performed. The storage medium may include mediums such as a movable storage device, ROM (Read-Only Memory), RAM (Random Access Memory), magnetic disc or optical disc, which may store program codes.

Optionally, when the integrated unit is achieved in a software functional module and sold or used as a separate product, it may also be stored in a computer readable storage medium. In view of the above mentioned, the substance or the part which contributes to the conventional technology of the technical solution of an embodiment of the disclosure may be embodied in a software product. The software product may be stored in a storage medium and may include several instructions for causing a desktop computer (may be a personal computer, a server or a network apparatus) to perform a part or the whole of the method according to the embodiments of the disclosure. The storage medium may include mediums such as a movable storage device, ROM (Read-Only Memory), RAM (Random Access Memory), magnetic disc or optical disc, which may store program codes.

The described above are only the specific implementing ways of the disclosure, but the scope of protection of the disclosure is not limited thereto. Any variations or substitutions that can be easily conceived by those skilled in the art in the technical scope disclosed by the disclosure fall within the scope of protection of the disclosure. Therefore, the scope of protection of the disclosure is based on the scope of protection of the claims attached.

1. A method for information processing applied in an electronic apparatus with a touch display unit, wherein M application identifiers one-to-one corresponding to M applications and a first non-full-screen window comprising a first display area and a second function area are displayed on the touch display unit, M being a positive integer; the first display area is used for displaying a first application, and the second function area comprises at least one virtual function key, the first non-full-screen window is smaller than the display area of the touch display unit, and the method comprises:
acquiring a first operation to the virtual function key in the second function area;
parsing the first operation to obtain a first parsing result, wherein the first parsing result indicates information for adjusting the first non-full-screen window;
determining a first transformation parameter in accordance with the first parsing result; and
transforming the first non-full-screen window by using the first transformation parameter to determine a second non-full-screen window for replacing the first non-full-screen window to make the first application displayed within the second non-full-screen window;
wherein the first non-full-screen window is different from the second non-full-screen window and the first transformation parameter at least comprises a parameter value, a matrix, a parameter group or a parameter set.

2. The method according to claim 1, wherein the second function area comprises a first virtual function key indicative of moving the first non-full-screen window and/or a second virtual function key indicative of scaling the first non-full-screen window.

3. The method according to claim 2, wherein determining a first transformation parameter in accordance with the first parsing result comprises:
determining the first transformation parameter in accordance with a distance and a direction for moving the first non-full-screen window indicated by the first parsing result and/or amplitude and a direction for scaling the first non-full-screen window indicated by the first parsing result in the case where an operation object of the first operation is the first virtual function key; and
transforming the first non-full-screen window by using the first transformation parameter to determine a second non-full-screen window.

4. The method according to claim 1, wherein the second function area further comprises a third virtual function key indicative of closing the first non-full-screen window; and the method further comprises:
acquiring the first operation for the third virtual function key in the second function area; and
closing the first non-full-screen window displayed on the touch display unit in response to the first operation for the third virtual function key.

5. The method according to claim 1, wherein the second function area further comprises a fourth virtual function key indicative of full-screen displaying the first non-full-screen window; and the method further comprises:
acquiring the first operation for the fourth virtual function key in the second function area; and
full-screen displaying the first non-full-screen window in response to the first operation for the fourth virtual function key.

6. The method according to claim 1, wherein transforming the first non-full-screen window by using the first transformation parameter to determine a second non-full-screen window comprises:
reading graphic buffer data of the first application;
converting the read graphic buffer data into graphic buffer data corresponding to the second non-full-screen window by using the first transformation parameter, and combining the graphic buffer data for the second non-full-screen window into frame buffer data corresponding to the touch display unit; and
displaying the second non-full-screen window of the first application on the touch display unit by using the frame buffer data.

7. The method according to claim 1, wherein determining a first transformation parameter in accordance with the first parsing result comprises:
displaying a third window for replacing the first non-full-screen window on the touch display unit to make the first application displayed in the third window in response to the first operation in the case where the first parsing result meets a first condition; the third window being different from the first non-full-screen window;
determining the first transformation parameter in response to the first operation in the case where the first parsing result meets a second condition.

8. The method according to claim 7, wherein the first parsing result comprises a duration parameter of a first touch event corresponding to the virtual function key which is triggered by the first operation; and
displaying the third window for replacing the first non-full-screen window on the touch display unit to make the first application displayed in the third window in response to the first operation in the case where the first parsing result meets the first condition comprises:
displaying the third window for replacing the first non-full-screen window on the touch display unit to make the first application displayed in the third window in the case where the duration parameter of the touch event received by the virtual function key is smaller than a preset threshold; the third window corresponding to the display area of the touch display unit.

9. The method according to claim 8, wherein the first parsing result further comprises a displacement parameter of the first touch event; and
determining the first transformation parameter in response to the first operation in the case where the first parsing result meets the second condition comprises:
determining the first transformation parameter according to the displacement parameter of the first touch event in the case where the duration parameter of the first touch event is equal to or greater than a preset threshold; and
transforming the first non-full-screen window into a second non-full-screen window with a first display area and a second function area by using the determined first transformation parameter to make the first application displayed in the first display area of the second non-full-screen window; the second non-full-screen window being bigger or smaller than the first non-full-screen window and being different from the third window.

10. The method according to claim 9, wherein the first parsing result further comprises a touch-point parameter of the first touch event; and
the method further comprises, before determining the first transformation parameter in response to the first operation,
judging whether the number of touch points sensed by the virtual function key, which is indicated by the touch-point parameter, meets a third condition; performing the step of determining the first transformation parameter in response to the first operation in the case where the number of the touch points meets the third condition; and determining the first transformation parameter according to the displacement parameter of the first touch event in the case where the number of the touch points does not meet the third condition; and
transforming the third window into a fourth non-full-screen window with a first display area and a second function area by using the determined first transformation parameter to make the first application displayed in the first display area of the fourth non-full-screen window; the position of the fourth window being different from the position of the third window.

11. The method according to claim 1, the method further comprises, before acquiring the first operation for the virtual function key in the second function area, full-screen display windows corresponding to multiple applications being transformed by the electronic apparatus by using a second transformation parameter, to obtain non-full-screen windows of the applications, wherein in the case where N non-full-screen windows is operated, the method of determining the first non-full-screen window from the N non-full-screen windows comprises:
determining the first non-full-screen window in a first state among N non-full-screen windows that are opened currently;
setting the first non-full-screen window to a first display state;
acquiring first display information corresponding to the first non-full-screen window;
determining display information of the second function area according to the first display information; and
generating the first non-full-screen window by using the first display information and the display information of the second function area.

12. The method according to claim 11, wherein the first non-full-screen window in the first state is the non-full-screen window, in which an interaction event takes place for the last time, among the N non-full-screen windows in which applications are operated in the non-full-screen mode.

13. The method according to claim 12, wherein generating the first non-full-screen window by using the first display information and the display information of the second function area comprises:
generating frame buffer data according to the first display information in the first non-full-screen window and the display information of the second function area; and
displaying the frame buffer data in the display area of the touch display unit.

14. The method according to claim 13, further comprising: before the generating frame buffer data of the display module according to the first display information in the first non-full-screen window and the display information of the second function area,
adding a display parameter of the second function area into the display information in the second function area.

15. The method according to claim 11, wherein the determining display information of the second function area according to the first display information comprises:
extracting a display position of the first display area of the first non-full-screen window from the first display information;
determining a display coordinate of the second function area according to the display position of the first display area, and determining graphic buffer data of the second function area; and
combining the display coordinate of the second function area and the graphic buffer data into the display information of the second function area.

16. An electronic apparatus with a touch display unit, wherein M application identifiers one-to-one corresponding to M applications and a first non-full-screen window comprising a first display area and a second function area are displayed on the touch display unit, M being a positive integer; the first display area is used for displaying a first application, and the second function area comprises at least one virtual function key, the first non-full-screen window being smaller than the display area of the touch display unit, and the electronic apparatus further comprises:
an acquiring unit, configured to acquire a first operation to the virtual function key in the second function area;
a parsing unit, configured to parse the first operation to obtain a first parsing result, wherein the first parsing result indicates information for adjusting the first non-full-screen window;
a first determining unit, configured to determine a first transformation parameter in accordance with the first parsing result; and
a second determining unit, configured to transform the first non-full-screen window by using the first transformation parameter to determine a second non-full-screen window for replacing the first non-full-screen window to make the first application displayed within the second non-full-screen window.

17. The electronic apparatus according to claim 16, wherein the touch display unit is further configured to display, on the second function area, a first virtual function key indicative of moving the first non-full-screen window and/or a second virtual function key indicative of scaling the first non-full-screen window.

18. The electronic apparatus according to claim 17, wherein the first determining unit is further configured to determine the first transformation parameter in accordance with the distance and direction for moving the first non-full-screen window indicated by the first parsing result and/or an amplitude and a direction for scaling the first non-full-screen window indicated by the first parsing result in the case where an operation object of the first operation is the first virtual function key.

19. The electronic apparatus according to claim 16, wherein
the touch display unit is further configured to display, on the second function area, a third virtual function key indicative of closing the first non-full-screen window;
the acquiring unit is further configured to acquire the first operation for the third virtual function key in the second function area; and
the touch display unit is further configured to close the first non-full-screen window displayed on the touch display unit in response to the first operation for the third virtual function key.

20. The electronic apparatus according to claim 16, wherein
the touch display unit is further configured to display, on the second function area, a fourth virtual function key indicative of full-screen displaying the first non-full-screen window;
the acquiring unit is further configured to acquire the first operation for the fourth virtual function key in the second function area; and
the touch display unit is further configured to full-screen display the first non-full-screen window in response to the first operation for the fourth virtual function key.

21. The electronic apparatus according to claim 16, wherein the first determining unit is further configured to:
read graphic buffer data of the first application;
convert the read graphic buffer data into graphic buffer data corresponding to the second non-full-screen window by using the first transformation parameter, and combine the graphic buffer data for the second non-full-screen window into frame buffer data corresponding to the touch display unit; and
display the second non-full-screen window of the first application on the touch display unit by using the frame buffer data, the second non-full-screen window being used for replacing the first non-full-screen window to make the first application displayed within the corresponding second non-full-screen window.

22. The electronic apparatus according to claim 16, wherein parsing unit is further configured to determining whether the first parsing result meets a first condition or meets a second condition;
the electronic apparatus further comprises a second processing unit, configured to display a third window for replacing the first non-full-screen window on the touch display unit to display the first application in the third window in response to the first operation in the case where the first parsing result meets the first condition; the third window being different from the first non-full-screen window; and
the second determining unit, further configured to, in the case where the first parsing result meets the second condition, acquire a first transformation parameter, and transform the first non-full-screen window into a second non-full-screen window by using the first transformation parameter to display the first application in the second non-full-screen window in response to the first operation; the second non-full-screen window being different from either of the first non-full-screen window or the third window.

23. The electronic apparatus according to claim 22, wherein the first parsing result comprises a duration parameter of a first touch event corresponding to the virtual function key which is triggered by the first operation; and
the second processing unit is further configured to, in the case where the duration parameter of the touch event received by the virtual function key is shorter than a preset threshold, display the third window for replacing the first non-full-screen window on the touch display unit to display the first application in the third window; the third window corresponding to the display area of the touch display unit.

24. The electronic apparatus according to claim 23, wherein the first parsing result further comprises a displacement parameter of the first touch event; and
the second determining unit is further configured to, in the case where the duration parameter of the first touch event is equal to or longer than the preset threshold, determine the first transformation parameter according to the displacement parameter of the first touch event; and transform the first non-full-screen window into a second non-full-screen window with a first display area and a corresponding second function area by using the determined first transformation parameter, to display the first application in the first display area of the second non-full-screen window; the second non-full-screen window being bigger or smaller than the first non-full-screen window and being different from the third window.

25. The electronic apparatus according to claim 24, wherein the first parsing result further comprises a touch-point parameter of the first touch event; and
the electronic apparatus further comprises: a judging unit and a fourth processing unit;
wherein the judging unit is configured to judge whether the number of touch points sensed by the virtual function key, which is indicated by the touch-point parameter, meets a third condition; trigger the second determining unit in the case where the number of the touch points meets the third condition; and trigger the fourth processing unit in the case where the number of the touch points does not meet the third condition; and
the fourth processing unit is configured to determine a corresponding first transformation parameter according to the displacement parameter of the first touch event; and transform the third window into a fourth window with a corresponding first display area and a corresponding second function area by using the determined first transformation parameter, to display the first application in the first display area of the fourth window; the position of the fourth window being different from the position of the third window.

26. The electronic apparatus according to claim 16, wherein the electronic apparatus further comprises a processing unit;
the touch display unit is further configured to transform a full-screen display window corresponding to the application by using a second transformation parameter; and select a first non-full-screen window in a first state from non-full-screen windows that are opened currently in the touch display unit in the case where N windows in which the application is run in a non-full-screen mode are opened, where N is an integer greater than or equal to 1, and the non-full-screen window in the non-full-screen mode is opened; and
the processing unit is configured to run a plurality applications; display, in a display area of the touch display unit, the first non-full-screen window in the first state determined among the non-full-screen windows that are opened currently; set the first non-full-screen window to a first display state; acquire first display information corresponding to the first non-full-screen window; determine display information of a second function area according to the first display information; and generate the first non-full-screen window by using the first display information and the display information of the second function area, and display the first non-full-screen window in the display area of the touch display unit.

27. The electronic apparatus according to claim 26, wherein the processing unit is further configured to switch the non-full-screen window in a second state into a second display state different from the first display state.

28. The electronic apparatus according to claim 27, wherein the processing unit is configured to set, as the first non-full-screen window in the first state, the non-full-screen window, in which an interaction event takes place for the last time, among the N windows in which the application is run in the non-full-screen mode.
